(19) United States
(12) Patent Application Publication
(10) Pub. No.: US 2013/0157186 A1
(43) Pub. Date: Jun. 20, 2013

(54) MAGNETIC CARRIER, TWO-COMPONENT DEVELOPER, REPLENISHING DEVELOPER, AND METHOD OF FORMING IMAGE

(71) Applicant: Samsung Electronics Co., Ltd., Suwon-si (KR)

(72) Inventors: Manabu ONO, Yokohama-si (JP); Osamu Ieda, Yokohama-si (JP); Takahiro Ishii, Yokohama-si (JP); Hiroaki Yoshida, Yokohama-si (JP); Akira Kambayashi, Yokohama-shi (JP); Hiroko Endo, Yokohama-si (JP); Motomi Noguchi, Yokohama-si (JP)

(73) Assignee: Samsung Electronics Co., Ltd., Suwon-si (KR)

(21) Appl. No.: 13/718,301

(22) Filed: Dec. 18, 2012

(30) Foreign Application Priority Data
Dec. 19, 2011 (JP) 2011-277738

(51) Int. Cl. G03G 9/107; G03G 13/08

(52) U.S. Cl. CPC G03G 9/1075; G03G 13/08
USPC 430/106.1; 430/123.5

(57) ABSTRACT

A magnetic carrier having excellent charge-imparting ability includes a magnetic particle and a coating layer disposed on a surface of the magnetic particle. The coating layer includes at least a resin component including an acrylic polymer and hydrotalcite dispersed in a form of particles having a predetermined number-average particle. A content of the hydrotalcite CH (parts by weight) is in a range of approximately 3 or more to approximately 30 parts by weight or less based on 100 parts by weight of the resin component. A content of the acrylic monomer unit CA (mol %) with respect to a total monomer unit included in the resin component and the content of the hydrotalcite CH satisfy the following relationship: 78≦CH×0.38+CA≦99.

### CROSS-REFERENCE TO RELATED APPLICATIONS

This application claims the priority benefit of Japanese Patent Application No. 2011-277738 filed on Dec. 19, 2011, in the Japan Patent Office, the disclosure of which is incorporated herein in its entirety by reference.

### BACKGROUND

1. Field

The following description relates to magnetic carriers, two-component developers, replenishing developers, and methods of forming an image used in an electrophotographic method, an electrostatic recording method, and an electrostatic printing method.

2. Description of the Related Art

In general, image formation using an electrophotographic method is performed through processes such as charging, exposure, development, transfer, and fixing. The image formation using an electrophotographic method may be broadly classified into a single-component developing method and a two-component developing method, according to a method of development. A magnetic carrier constituting a portion of a two-component developer used in the two-component developing method is broadly classified into a coated carrier having a coating layer on the surface thereof and an uncoated carrier having no coating layer, and because the coated carrier may be excellent with respect to a lifetime or high functionality of the developer, various types of the coated carriers have been developed and commercialized.

In the case that the two-component developing method is used, there is a need to provide sufficient charge-imparting ability to the magnetic carrier and also allow the magnetic carrier to maintain the ability, in order to quickly provide appropriate chargeability to a toner in any environment from low temperature and low humidity to high temperature and high humidity, and also maintain the chargeability for a prolonged period of time.

In particular, charges generated on the surface of the magnetic carrier may be easily leaked under a high-temperature and high-humidity condition, thus decreasing charge-imparting ability of the magnetic carrier. Also, the surface of the magnetic carrier is contaminated with a toner material (hereinafter, referred to as “toner spent”) during repetitive printing cycles which decreases the charge-imparting ability. As a result, the toner may not be quickly and appropriately charged by mixing in a short period of time and thus, an absolute value of charge quantity may be decreased and defects, such as toner scattering or background fogging, may occur. The charge leakage from the surface of the magnetic carrier under a high-temperature and high-humidity condition occurs due to the fact that a coated resin layer on the surface of the magnetic carrier adsorbs moisture in an operating environment and the generated charges are aerially discharged through the adsorbed moisture.

However, since the number of printed pages per unit time has been increased in a latest image forming apparatus according to a digital electrophotographic method, there is a need to provide appropriate chargeability to a replenishing toner by mixing a newly replenished toner (hereinafter, referred to as “replenishing toner”) and a magnetic carrier in a short period of time as the toner is consumed due to the formation of images in an image forming apparatus using a two-component developer, and there is also a need to repeatedly and stably perform this over a prolonged period of time.

Accordingly, many proposals for completely mixing the replenishing toner and the magnetic carrier in a limited space and time have been made (e.g., see Japanese Patent Application Laid-Open Publication No. 2004-326034).

With respect to the foregoing image forming apparatus, mixability of the magnetic carrier with the replenishing toner due to mechanical dispersion force may be excellent, but a two-component developer suitable for the image forming apparatus has not been proposed.

A magnetic carrier in a two-component developer appropriately charges a toner when being mixed with the toner and the toner is then supported on surfaces of magnetic carrier particles to prepare for image formation. In the case that a so-called “free toner”, a toner that is not supported on the surfaces of the magnetic carrier particles, is generated, the free toner may be a cause of various defects such as toner scattering or background fogging. In particular, such phenomena may be facilitated in an image forming apparatus requiring complete mixing of the replenishing toner and the magnetic carrier in a short mixing time as described above.

In particular, the demand for a relatively small apparatus aimed at printing images on A4 size paper has recently been increased and thus, there is a need to develop a two-component developer suitable for the image forming apparatus requiring complete mixing of the replenishing toner and the magnetic carrier in a short mixing time.

Also, in view of miniaturization of the image forming apparatus and reduction of the amounts of released chemical substances, a so-called “contact charging method”, in which a surface of an electrostatic latent image carrier is charged by allowing a charging member to be in contact with the electrostatic latent image carrier and externally applying a voltage to the charging member, has been widely used for a charging device in a charging process. In addition, because an increase in the lifetime of the electrostatic latent image carrier is promoted by preventing abrasion of a surface of the electrostatic latent image carrier, only a direct voltage, rather than a direct voltage superposed with an alternating voltage, also tends to be used as the externally applied voltage.

However, with respect to the contact charging device using only a direct voltage, because residual toners not removed from the surface of the electrostatic latent image carrier after a transfer process are adhered to a surface of the charging member to become a main cause of charging defects of the electrostatic latent image carrier, an effect of preventing the adhesion to the surface of the charging member has been required for the two-component developer itself.

A magnetic carrier, in which magnetic particles are coated with a thermoplastic resin having a cycloaliphatic group, resistant to moisture adsorption, has been proposed for the foregoing defects (e.g., see Japanese Patent Application Laid-Open Publication No. 2008-122444).

In the magnetic carrier, because a portion of the cycloaliphatic group contained in a coated resin layer (hereinafter, simply referred to as “coating layer”) may be resistant to retain moisture, environmental dependence in the initial stage of printing may be resolved. However, because the thermoplastic resin having a cycloaliphatic group has low charge-imparting ability to a negatively chargeable toner, an absolute value of charge quantity of the toner is decreased, and thus, defects, such as toner scattering or background fogging, are facilitated. Therefore, with respect to the magnetic carrier, increasing the absolute value of charge quantity of the toner and the charge-imparting ability of the magnetic carrier has been attempted by including a nitrogen-containing acrylic monomer in the coating layer. However, when the image formation is repeated many times over a prolonged period of time, toner spent occurs on the surface of the magnetic carrier.

In order to prevent the toner spent, use of low surface energy resins, such as a silicone resin or a fluorocarbon resin, on the coating layer has been known (e.g., see Japanese Patent Application Laid-Open Publication No. 59-228261, Japanese Patent Application Laid-Open Publication No. 59-104664, Japanese Patent Application Laid-Open Publication No. 60-186844, and Japanese Patent Application Laid-Open Publication No. 64-13560).

However, in the case that these resins are used in the resin layer, an effect of preventing the toner spent may be limited, and the effect may not only disappear during repetitive printing cycles, but peeling of the resin layer may also occur in the case that adhesion to magnetic particles, a core material of the magnetic carrier, is not sufficiently obtained. Therefore, a study of the magnetic carrier for being used in the image forming apparatus, in which the replenishing toner and the magnetic carrier must be mixed in a short period of time, may still be insufficient.

Meanwhile, methods of improving environmental stability (e.g., see Japanese Patent No. 3582020 and Japanese Patent Application Laid-Open Publication No. 7-56395), in which hydrophilic silica particles are added into a resin layer to optimize a moisture content balance with a toner and thus, changes in charging order due to environmental changes are prevented, or methods of controlling charging by adding fine particles having high charge-imparting ability (e.g., see Japanese Patent Application Laid-Open Publication No. 7-261465 and Japanese Patent Application Laid-Open Publication No. 9-127737) have been proposed. However, these publications may not address all the foregoing limitations.

Also, a method of controlling a resistance by including a lamellar double hydroxide, such as hydrotalcite, in a coating layer for the purpose of improving image quality by decreasing the resistance of a carrier has been proposed (e.g., see Japanese Patent Application Laid-Open Publication No. 2011-69853). However, in this case, because the lamellar double hydroxide, having a resistance higher than that of the magnetic particles, is used, manufacturing techniques, such as fixing the lamellar double hydroxide on the surfaces of the magnetic particles or multi-coating during the formation of the coating layer, become essential to thus generate constraints on production or cause an increase in the amount of the used lamellar double hydroxide.

### SUMMARY

Additional aspects and/or advantages will be set forth in part in the description which follows and, in part, will be apparent from the description, or may be learned by practice of the invention.

The following description relates to a magnetic carrier, a two-component developer, a replenishing developer, and a method of forming an image, in which high developability may be obtained in any environment from a condition of low temperature and low humidity to a condition of high temperature and high humidity, excellent reproducibility of small-point characters or fine lines may be obtained, background fogging is reduced, and stable performances may be exhibited over a prolonged period of time.

The following description relates to a two-component developer, a replenishing developer, and a method of forming an image, in which excellent matching property with an image forming apparatus is obtained.

In particular, the following description relates to a two-component developer, a replenishing developer, and a method of forming an image, which are suitable for an image forming apparatus using a contact charging method in which only a direct voltage is applied to a charging member in a charging process, or a small high-speed image forming apparatus in which insufficient mixing of a replenishing toner and magnetic carriers may be facilitated.

According to an aspect of the present general inventive concept, a magnetic carrier includes a magnetic particle; and a coating layer disposed on a surface of the magnetic particle, wherein the coating layer includes at least a resin component containing approximately 70 wt % or more of a polymer including an acrylic monomer as a component and hydrotalcite dispersed in a form of particles having a number-average particle diameter ranging from approximately 0.1 μm or more to approximately 0.6 μm or less, a content of the hydrotalcite C_{H} in parts by weight is in a range of approximately 3 parts by weight or more to approximately 30 parts by weight or less based on 100 parts by weight of the resin component, and a content of the acrylic monomer unit C_{A} in mol % with respect to a total monomer unit included in the resin component and the content of the hydrotalcite C_{H} in parts by weight satisfy the following relationship: 78≦C_{H}×0.38+C_{A}≦99, where 3≦C_{H}≦30.

According to an aspect of the present general inventive concept, a two-component developer includes the magnetic carrier and a toner, and a replenishing developer includes the magnetic carrier and a toner.

According to an aspect of the present general inventive concept, a method of forming an image includes using the two-component developer or the replenishing developer.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a schematic cross-sectional view illustrating a magnetic carrier according to the present general inventive concept;

FIG. 2 is a schematic view illustrating a relationship between a content of an acrylic monomer unit C_{A} (mol %) with respect to a total monomer unit included in a resin component constituting a coating layer formed on a surface of the magnetic carrier according to the present general inventive concept and a content of hydrotalcite C_{H} (parts by weight) contained in the coating layer;

FIG. 3 is a schematic diagram illustrating an embodiment of a full-color image forming apparatus in which a two-component developer and/or a replenishing developer according to the present general inventive concept are used;

FIG. 4 is a schematic view illustrating a movement path of a developer in an image forming apparatus using a replenishing developer; and

FIG. 5 is an electron micrograph of a cross section of a magnetic carrier illustrating an example of a dispersion state of hydrotalcite in the coating layer of the magnetic carrier according to the present general inventive concept.

### DETAILED DESCRIPTION

The present general inventive concept will now be described more fully with reference to the accompanying drawings, in which exemplary embodiments of the present general inventive concept are shown. As used herein, the term “and/or” includes any and all combinations of one or more of the associated listed items.

Forming a coating layer including a polymer including an acrylic monomer as a component and hydrotalcite whose state of being is optimized on a surface of a magnetic carrier in a two-component developer significantly improves charge-imparting ability to a toner and simultaneously, high-quality image printing is possible over a prolonged period of time by precisely controlling a particle size distribution of the toner, inorganic particles included in the surface of the toner, and a shape of the magnetic carrier or the toner, thereby leading to completion of the present general inventive concept.

Hereinafter, the present general inventive concept will be described in detail.

(Magnetic Carrier)

First, configurational characteristics or raw materials of a magnetic carrier according to the present general inventive concept will be described.

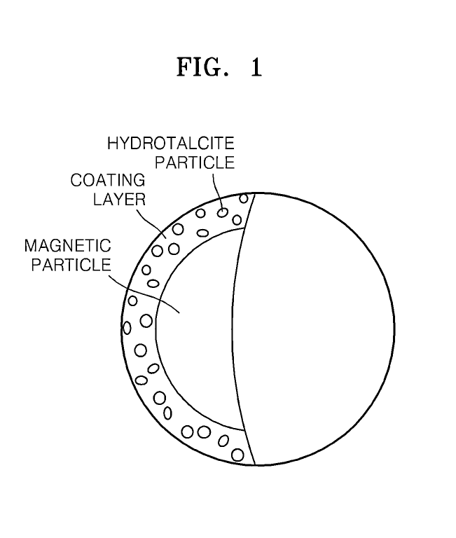

The magnetic carrier according to the present general inventive concept is a coated carrier formed by forming a coating layer on a surface of the magnetic particle, and contains hydrotalcite particles in the resin layer (see FIG. 1).

The magnetic carrier is configured as above and thus, the foregoing limitations may be effectively addressed.

That is, because the magnetic carrier according to the present general inventive concept forms the coating layer containing hydrotalcite on the surface of the magnetic particle in an appropriate state, the hydrotalcite quickly provides appropriate chargeability to the toner in any environment from a condition of low temperature and low humidity to a condition of high temperature and high humidity over a prolonged period of time, and thus, a good print-out image may stably be obtained.

Currently, the following mechanism based on charge maintainability of hydrotalcite is considered as the reason for the above.

Hydrotalcite is a compound having a lamellar double hydroxide structure expressed as the following General Formula (I).

[M²⁺₁₋ₓM³⁺ₓ(OH)₂] [Aⁿ⁻_{x/n}.mH₂O] General Formula (I)

where, M⁺² is a divalent metal ion, M³⁺ is a trivalent metal ion, Aⁿ⁻ represents an n-valent anion, and m≦0.

Herein, [M²⁺₁₋ₓM³⁺ₓ(OH)₂], the first half of General Formula (I), is a host layer, a metal hydroxide layer, and is overall positively charged to a value of x, because a portion of the divalent metal ion is substituted with the trivalent metal ion. The anions, a guest, are disposed between the host layers to compensate for the positive charge, and water molecules may be also disposed.

Therefore, because the hydrotalcite particles have a structure, in which anions or water molecules are introduced between the positively charged host layers, surfaces of the particles are positively charged, and thus, appropriate chargeability may be quickly provided to the toner. In particular, it is assumed that because the surfaces of the particles may be resistant to moisture even in a high-temperature and high-humidity environment, charge-imparting ability may not be greatly decreased as in a positively chargeable charge control agent that has been conventionally widely used, and thus, good charge-imparting ability may be maintained.

The hydrotalcite used in the present general inventive concept may include Mg²⁺ as a divalent metal ion M+² and Al³⁺ as a trivalent metal ion M³⁺ in view of charge-imparting ability and stability.

Also, examples of the n-valent anion in [Aⁿ⁻_{x/n}.mH₂O], the second half of General Formula (I), may be a carbonate ion, a sulfate ion, a hydroxide ion, or a chloride ion, and for example, a carbonate ion, a hydroxide ion, and a chloride ion may be used in view of providing chargeability to the toner.

Any of pulverized products of clay minerals (e.g., Mg₆Al₂(OH)₁₆CO₃4H₂O) in nature or industrially manufactured powder particles may be used as the hydrotalcite used in the present general inventive concept.

The hydrotalcite used in the present general inventive concept is dispersed in the coating layer of the surface of the magnetic carrier in a form of particles having a number-average particle diameter (D1) ranging from approximately 0.1 μm or more to approximately 0.6 μm or less, and, specifically, may have a number-average particle diameter ranging from approximately 0.3 μm or more to approximately 0.5 μm or less. When the hydrotalcite is dispersed in the form of particles having a number-average particle diameter less than approximately 0.1 μm, advantages of the lamellar double hydroxide structure of the hydrotalcite may disappear, and thus, a decrease in charge-imparting ability in a high-temperature and high-humidity environment may be facilitated. Also, when the hydrotalcite is dispersed in the form of particles having a number-average particle diameter greater than approximately 0.6 μm, possibility of being in contact with the toner may decrease, and thus, charge-imparting ability may not only be insufficient, but a poor dispersion in the resin layer or a decrease in the strength of the resin layer may occur.

Although the surfaces of the hydrotalcite particles used in the present general inventive concept may be treated by using a treating agent, the surfaces thereof may not be treated in order to obtain a sufficient effect.

The hydrotalcite used in the present general inventive concept may include divalent and/or trivalent metal ions in addition to Mg²⁺ or Al³⁺, and furthermore, a composition substituting a portion of the trivalent metal ions with tetravalent metal ions or multi-component hydrotalcite combined with three or more types of metal ions combined with monovalent to trivalent metal ions may be used. However, a molar ratio (Mg/Al) of magnesium (Mg) to aluminum (Al) contained in the hydrotalcite may be controlled to a range of approximately 0.25 or more to approximately 3.50 or less, and particularly, may be in a range of approximately 1.50 or more to approximately 3.00 or less.

When the molar ratio of Mg to Al is less than approximately 0.25, charge-imparting ability in a high-temperature and high-humidity environment may rapidly decrease. It is estimated that this is due to the fact that nucleation of Al(OH)₃ begins to start as adjacent portions between Al⁺³ sites are generated. Also, when the molar ratio of Mg to Al is greater than approximately 3.00, positive chargeability of the surface of the hydrotalcite decreases so that the charge-imparting ability to the toner also decreases.

The hydrotalcite used in the present general inventive concept is added in an amount ranging from approximately 3 parts by weight or more to approximately 30 parts by weight or less based on 100 parts by weight of a resin component constituting the resin layer formed on the surfaces of the magnetic particle, and may be added in an amount ranging from approximately 5 parts by weight or more to approximately 17 parts by weight or less.

When the amount of the added hydrotalcite particles is less than approximately 3 parts by weight, an effect of adding hydrotalcite may not be sufficiently obtained, and when the amount of the added hydrotalcite particles is greater than approximately 30 parts by weight, a so-called “carrier adhesion”, in which the magnetic carrier itself is developed on a surface of an electrostatic latent image carrier, may occur, or trouble caused by separation of the hydrotalcite particles or the decrease in the strength of the resin layer on the surface of the magnetic carrier may frequently occur.

A state of an acrylic component in the resin component and hydrotalcite present in the resin component may be optimized by adding approximately 70 wt % or more of a polymer (hereinafter, referred to as “acrylic resin”) including an acrylic monomer as a component to the resin component constituting the coating layer formed on the surfaces of the magnetic particles according to the present general inventive concept, and thus, charge-imparting ability of the magnetic carrier may be synergistically improved.

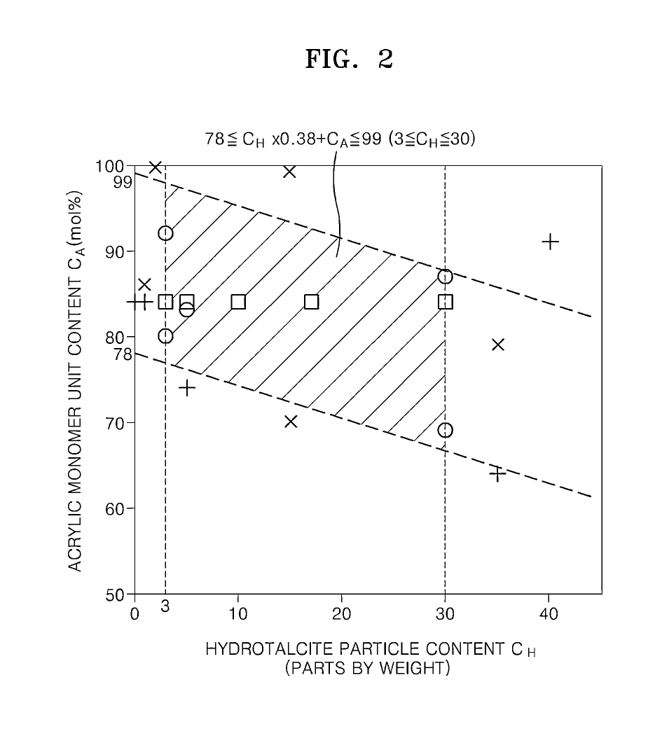

In particular, the effect of adding hydrotalcite may be sufficiently obtained when a content of the acrylic monomer unit C_{A} (mol %) with respect to a total monomer unit in the resin component constituting the coating layer and a content of the hydrotalcite C_{H} (parts by weight) satisfy the following relationship and thus, ideal charge-imparting ability may be provided to the magnetic carrier (see FIG. 2):

78≦sC_{H}×0.38+C_{A}≦99 (where 3≦C_{H}≦30).

When a value of the “C_{H}×0.38+C_{A}” is less than approximately 78, the charge-imparting ability to the toner may be insufficient, and image defects, such as deterioration of image density or background fogging, or limitations in matching property with an image forming apparatus, such as toner scattering, may occur under a high-temperature and high-humidity condition.

In contrast, when the value of the “C_{H}×0.38+C_{A}” is greater than approximately 99, image formation particularly under a low-temperature and low-humidity condition may be impaired because the charge-imparting ability to the toner may be excessive.

In particular, the foregoing limitations may be noticeable in a high-speed small apparatus aimed at printing images on A4 size paper, in which a replenishing toner and a magnetic carrier are required to be mixed in a short mixing time, but such limitations may be prevented in advance by controlling the value of the “C_{H}×0.38+C_{A}” to be within a predetermined range.

The acrylic resin used in the resin component constituting the coating layer according to the present general inventive concept may be obtained by homopolymerization or copolymerization of an acrylic monomer and includes an acrylic monomer unit.

The acrylic monomer is a monomer having an acrylic group and/or a methacrylic group. Specific examples of the acrylic monomer may be acrylic acid, methacrylic acid, and an ester thereof, and acrylamide, methacrylamide, acrylonitrile, and methacrylonitrile. Specific examples of the acrylic resin may be polyacrylic acid, polymethacrylic acid, poly(methyl acrylate), poly(methyl methacrylate), poly(isobutyl acrylate), poly(isobutyl methacrylate), and poly(cyclohexyl methacrylate), or a copolymer of styrene with at least one monomer constituting the above polymers. Among these polymers, a methyl methacrylate-styrene copolymer, an isobutyl acrylate-styrene copolymer, and isobutyl methacrylate-styrene copolymer may be used because the effect of adding the hydrotalcite may be further increased.

The resin component constituting the resin layer according to the present general inventive concept may be used in combination with at least one resin (hereinafter, referred to as “other resin”) among typically known thermoplastic resins or thermosetting resins so long as the resin component contains approximately 70 wt % or more of the foregoing acrylic resin. Examples of the thermoplastic resin may be polystyrene, a styrene-butadiene copolymer, an ethylene-vinyl acetate copolymer, polyvinylchloride, polyvinyl acetate, a polyvinylidene fluoride resin, a fluorocarbon resin, polyvinyl alcohol, etc. Examples of the theremosetting resin may be a silicone resin or a phenolic resin. In particular, it may be expected that a fluorine-containing resin, a silicone resin, or an acrylic-modified silicone resin may improve durability of the magnetic carrier or matching property with an image forming apparatus.

Also, in the case that the foregoing “other resin” is used in combination with the acrylic resin, the content of the acrylic monomer unit C_{A} (mol %) with respect to the total monomer unit in the resin component constituting the coating layer may be substituted with a correction value (C_{A}′×M/100) (where M≦70), in which a content of the acrylic monomer unit C_{A}′ (mol %) in the acrylic resin is multiplied by a content of the acrylic resin M (wt %) in the resin component constituting the coating layer.

In the resin component constituting the resin layer of the magnetic carrier, a tetrahydrofuran (THF) soluble component (hereinafter, referred to as “THF soluble fraction”) is approximately 90 wt % of more of the resin component, and also, the weight-average molecular weight (M_{w}) measured by gel permeation chromatography (GPC) on the tetrahydrofuran (THF) soluble fraction may be in a range of approximately 30,000 or more to approximately 300,000 or less.

When the resin layer is formed on the surface of the magnetic particle in the present general inventive concept, a so-called “wet method”, in which magnetic particle and a resin component dissolved or dispersed in a solvent are in contact with each other to coat the surface of the magnetic particle with the resin component and the resin layer is then formed by removing the solvent through heating, for example, may be used.

By specifying an amount of the THF soluble fraction in the resin component and the M_{w} as above, a state of the formed coating layer may not only be improved, but this may also be reflected to the optimization of dispersion of the hydrotalcite particles in the resin layer, and thus, the charge-imparting ability to the magnetic carrier may be improved.

Also, appropriate wear resistance is provided to the resin layer of the magnetic carrier and thus, wear resistance of the resin layer may be improved. As a result, because the surface of the magnetic carrier is always refreshed through the period of use, deterioration of image quality due to the toner spent may be prevented in advance. Also, because the resin layer repeatedly refreshed is uniform in a direction of thickness of the resin layer, the effect of adding the hydrotalcite may not disappear over a prolonged period of time and thus initial performance may be stably maintained over a prolonged period of time.

The state of the coating layer formed on the surface of the magnetic particle in the present general inventive concept may be controlled by an amount of the used resin component constituting the resin layer with respect to the magnetic particle and a preparation method thereof, and thus, the coating layer may be formed entirely or partially over the surface of the magnetic particle.

The coating layer on the surface of the magnetic particle may include conductive particles. The conductive particles included in the coating layer may include carbon black particles, graphite particles, zinc oxide particles, and tin oxide particles, and particularly, carbon black particles may appropriately control specific resistance of the magnetic carrier.

Also, resin particles, such as melamine resin, polyamide, and phenolic resin particles, or a known charge control agent, or inorganic particles, such as silica particles, may be added to the coating layer of the surface of the magnetic particle for the purpose of controlling charge-imparting ability or increasing release property and/or durability.

Known magnetic particles, ferrite particles, or magnetic material-dispersed resin particles may be used as the magnetic particle used in the present general inventive concept. As described below, because a shape factor ML²/A of the magnetic carrier may be controlled to be lower than that of the toner in advance, magnetic particle having high sphericity may be used. Also, a median particle diameter (D50) based on a volume distribution of the magnetic particles may be in a range of approximately 20 μm or more to approximately 70 μm or less in view of matching property with an image forming apparatus or preventing toner spent.

(Two-Component Developer)

Next, configurational characteristics or raw materials of a two-component developer according to the present general inventive concept will be described.

The two-component developer according to the present general inventive concept is composed of the toner and the magnetic carrier obtained by forming the coating layer optimizing the existence state of hydrotalcite and a polymer containing an acrylic monomer as a component on the surface of the magnetic carrier.

In particular, in a preferred example of the two-component developer of the present general inventive concept, toner particles at least containing a binder resin and a colorant, and inorganic particles having a number-average particle diameter ranging from approximately 0.01 μm or more to approximately 0.15 μm or less are combined with the foregoing magnetic carrier, and simultaneously, the shape factor ML²/A of the magnetic carrier is controlled to be lower than that of the toner and the shape factor ML²/A of the toner is controlled to be in a range of approximately 120 or more to approximately 160 or less such that the two-component developer of the present general inventive concept may sufficiently promote the charge-imparting ability of the magnetic carrier according to the present general inventive concept and at the same time, may maintain the state thereof over a prolonged period of time.

The shape factor ML²/A of the magnetic carrier or the toner in the present general inventive concept is used as a simple method of quantitatively expressing shapes of these particles, and is calculated by using the following formula.

$$Shape factor {ML}^{2} \text{/} A = \frac{\begin{matrix}absolute maximum \\ length of a particle\end{matrix}}{projected area of a particle} \times \frac{π}{4} \times 100 \qquad [ Mathematical Formula 1 ]$$

where, the term “projected area of a particle” denotes a binarized area of projected image of a magnetic carrier particle or a toner particle, and the term “absolute maximum length of a particle” denotes a maximum length among distances between two random points on a circumference of the image of the project image of a particle.

The shape factor ML²/A of the present general inventive concept is an index representing a degree of deformation with respect to a perfect sphere of the magnetic carrier or the toner, which is 100 when the magnetic carrier or the toner is a perfect sphere, and the shape factor ML²/A increases as the perfect sphere is more deformed.

Because the shape factor ML²/A of the magnetic carrier is controlled to be lower than that of the toner and the shape factor ML²/A of the toner is controlled to be in a range of approximately 120 or more to approximately 160 or less, a state of contact between the magnetic carrier and the toner may improve, and thus, charge-imparting ability may be further improved. Also, a cleaning effect by the toner to be later described may be further increased.

Because the toner according to the present general inventive concept includes fine inorganic particles having a number-average particle diameter (D1) ranging from approximately 0.01 μm or more to approximately 0.15 μm or less with the toner particles, a possibility of its being in contact with or approaching to the hydrotalcite particles contained in the coating layer formed on the surface of the magnetic carrier may be increased and simultaneously, the inorganic particles may clean the coating layer of the magnetic carrier. Therefore, the toner spent may be prevented and the charge-imparting ability of the magnetic carrier may be maintained over a prolonged period of time.

When the number-average particle diameter of the fine inorganic particles is less than approximately 0.01 μm, the inorganic particles themselves are prematurely buried in the coating layer of the surface of the magnetic carrier or in the toner particles, and thus, the effect of addition may not only disappear, but charging of the toner may also be adversely affected. Also, when the number-average particle diameter of the fine inorganic particles is greater than approximately 0.15 μm, the cleaning effect on the surface of the magnetic carrier may be insufficiently obtained, and matching property with an image forming apparatus may also be adversely affected.

The fine inorganic particles used in the present general inventive concept may sufficiently promote the charge-imparting ability of the magnetic carrier by being added in an amount ranging from approximately 2 parts by weight or more to approximately 5 parts by weight or less based on 100 parts by weight of the toner particles.

The type of fine inorganic particles used in the present general inventive concept is not particularly limited so long as they do not obstruct charging of the toner and may clean the surface of the magnetic carrier, and typically known inorganic fine particles, for example, silica fine particles, titania fine particles, and surface-treated fine particles thereof, may be used. Among these particles, inorganic particles surface-treated with silicone oil may be used, because the particles have an effect of increasing a speed of charge-imparting from the magnetic carrier, and for example, silicone oil-treated silica fine particles may be particularly used in which surfaces thereof are treated by using approximately 5 parts by weight to approximately 20 parts by weight of silicone oil based on 100 parts by weight of silica particles.

Because the two-component developer of the present general inventive concept may be appropriately charged from the magnetic carrier according to the present general inventive concept even in the case that a weight-average particle diameter of the toner in the two-component developer is decreased to a range of approximately 4.0 μm or more to approximately 8.0 μm or less, digital development of microspot latent images may be stably performed, and thus, images from small-point characters or fine lines may be stably and faithfully reproduced.

Also, by controlling the number of the toner particles having a diameter of approximately 3 μm or less in a particle diameter frequency distribution based on the number of the toner particles to be approximately 6% or less and thus, charge-imparting from the magnetic carrier may be further increased.

The two-component developer is configured as above and thus, the magnetic carrier may quickly provide appropriate chargeability to the replenishing toner regardless of an operating environment. As a result, good images may be formed and simultaneously, the toner may be supported on the surface of the magnetic carrier even in the case that the magnetic carrier and the replenishing toner are mixed in a short period of time. Therefore, defects due to a free toner may be prevented in advance.

The shape factor ML²/A of the toner or the magnetic carrier according to the present general inventive concept, or the particle diameter frequency distribution may be controlled by know methods during the preparations thereof.

The toner particles used in the present general inventive concept may include at least a binder resin and a colorant, and may be obtained by using an emulsion aggregation method, a suspension polymerization method, an association polymerization method, or a kneading pulverization method, for example. However, the preparation method thereof is not particularly limited.

Typically known binder resin and colorant may be used as the binder resin and the colorant used in the toner particles. Examples of the binder resin may be a styrene-based copolymer resin, a polyester resin, or a hybrid resin having a polyester unit and a vinyl-based polymer unit. When an organic dye or pigment is used as a colorant, the colorant is added in an amount ranging from approximately 1 part by weight to approximately 10 parts by weight based on 100 parts by weight of the binder resin, and thus, the colorant may not affect the charge-imparting from the magnetic carrier.

The toner particles used in the present general inventive concept may include a charge control agent or a release agent. Examples of the charge control agent may be metal compounds of an aromatic carboxylic acid such as salicylic acid, metal salts or metal complexes of an azo dye or an azo pigment, polymer type compounds having a sulfonic acid or carboxylic acid group in a side chain, boron compounds, urea compounds, silicon compounds, and calixarenes. Also, the release agent may include a paraffin wax or a derivative thereof, a higher aliphatic alcohol or a higher fatty acid, or an ester thereof, and the release agent having a peak temperature of a maximum endothermic peak measured by differential scanning calorimetry (DSC) ranging from approximately 50° C. to approximately 120° C. may be used in view of preventing toner spent.

Further, the two-component developer of the present general inventive concept may provide excellent chargeability to the toner by the charge-imparting ability of the magnetic carrier even in the case that the charge control agent is not added to the toner particles. As a result, the toner spent caused by the charge control agent may be prevented in advance and simultaneously, effects of the toner spent due to other toner materials, such as the colorant or the release agent, may be minimized. Therefore, defects, such as the matching property with an image forming apparatus, may be prevented in advance.

(Replenishing Developer)

Next, the replenishing developer of the present general inventive concept will be described in detail.

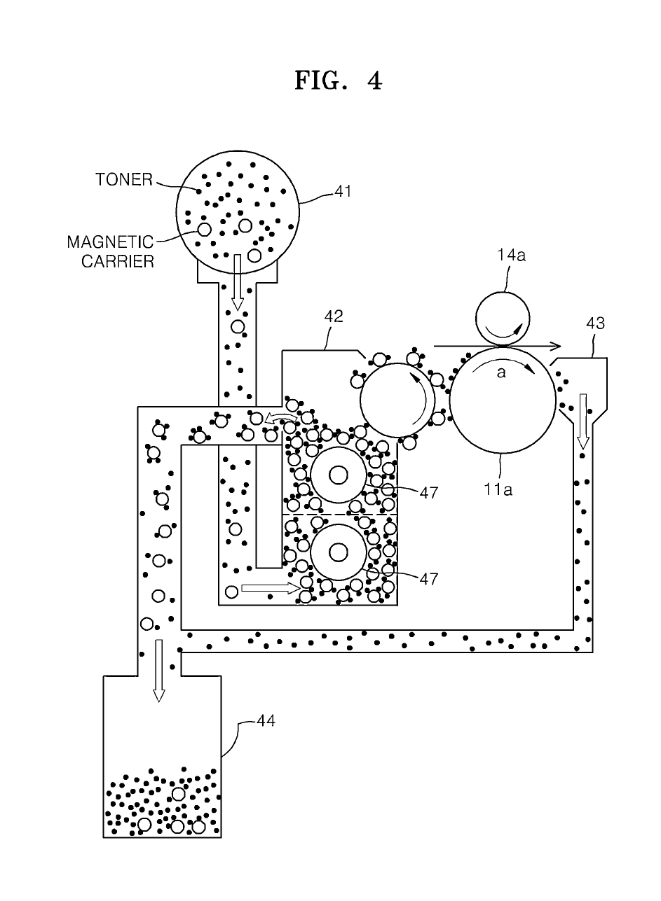

The replenishing developer of the present general inventive concept may also be used as a replenishing developer used in a two-component developing method (see FIG. 4) in which development is performed while the replenishing developer is supplied to a developing device and excessive magnetic carriers inside the developing device are discharged from the developing device. Because the replenishing developer is configured as above, performance of the two-component developer in the developing device may be maintained. In the case of that the two-component developer is used as a replenishing developer, a weight ratio of the magnetic carrier is controlled to be in a range of approximately 2 parts by weight or more to approximately 50 parts by weight or less based on 100 parts by weight of the toner. The replenishing developer is used as above and thus, the performance of the two-component developer in the developing device may be stably maintained over a prolonged period of time. In the present general inventive concept, because new magnetic carriers having high charge-imparting ability together with a new toner are continuously supplied from the replenishing developer, durability of the two-component developer of the present general inventive concept is improved, and thus, more stable image output may be obtained even over a prolonged period of use. Also, in an image forming apparatus using the foregoing replenishing developer, an increased amount of the magnetic carriers caused by the magnetic carriers contained in the supplied replenishing developer may be discharged from the developing device and finally conveyed to another recovery container.

Further, the magnetic carrier and the toner used in the two-component developer first charged into the developing device (hereinafter, referred to as “developer for start”) and the replenishing developer may be the same or different from each other.

(Image Forming Method)

Also, an image forming method, in which the developer of the present general inventive concept is appropriately used, will be described.

The image forming method includes charging an electrostatic latent image carrier by applying a voltage to a charging member; forming an electrostatic latent image on the electrostatic latent image carrier charged in the charging; developing the electrostatic latent image by using a two-component developer and forming a toner image on the electrostatic latent image carrier; transferring the toner image to a transfer material through or not through an intermediate transfer body being disposed therebetween; and fixing the toner image transferred to the transfer material to the transfer material, wherein the two-component developer includes a magnetic carrier and a toner, in which the magnetic carrier is the foregoing magnetic carrier obtained by forming a resin layer containing hydrotalcite on the surface of the magnetic particle.

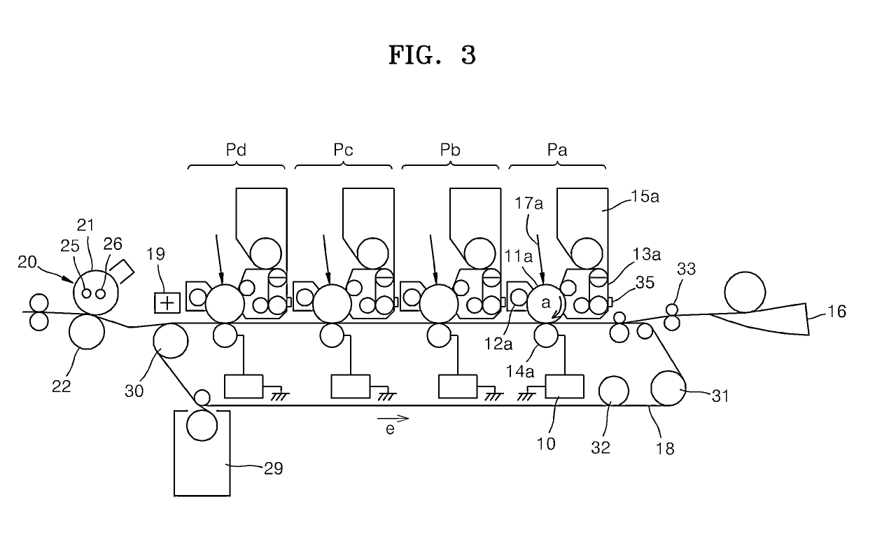

FIG. 3 is a schematic view illustrating a full-color image forming apparatus in which the image forming method of the present general inventive concept is used.

In a main body of the full-color image forming apparatus, a first image forming unit Pa, a second image forming unit Pb, a third image forming unit Pc, and a fourth image forming unit Pd are installed to each form toner images having different colors on the transfer material through the latent image forming process, the developing process, and the transfer process.

A configuration of each image forming unit installed in the image forming apparatus will be described by using the first image forming unit Pa as an example.

The first image forming unit Pa includes a photoreceptor 11a as an electrostatic latent image carrier and the photoreceptor 11a rotates and moves in a direction of arrow denoted as “a” direction. A charging roller 12a like a primary charger as a charging device is disposed to be in contact with a surface of the photoreceptor 11a. An exposure apparatus not shown in the drawing irradiates exposure light 17a on the photoreceptor 11a having a surface uniformly charged by the charging roller 12a so as to form an electrostatic latent image. A developing device 13a for forming a color toner image by developing the electrostatic latent image supported on the photoreceptor 11a includes a color toner. A transfer roller 14a as a transfer device transfer the color toner image formed on the surface of the photoreceptor 11a to a surface of a transfer material (recording material) fed from a transfer material feeding device 16 and conveyed by a belt-shaped transfer material carrier 18. The transfer roller 14a may apply a transfer bias generated by a transfer bias applying device 10 by abutting on a back side of the transfer material carrier 18.

The photoreceptor 11a is uniformly primarily charged by the charging roller 12a and the first image forming unit Pa then forms a electrostatic latent image on the photoreceptor by using the exposure light 17a from the exposure apparatus, and the electrostatic latent image is developed by using the developing device 13a with the color toner. The developed color toner image is transferred to the surface of the transfer material by the transfer bias applied from the transfer roller 14a abutting on the back side of the belt-shaped transfer material carrier 18 supporting and conveying the transfer material to a first transfer portion (a position in which the photoreceptor abuts on the transfer material).

When a weight percentage (wt %) of the toner (hereinafter, referred to as “T/C”) in the developer is decreased as the toner is consumed by the development, the decrease thereof is detected by using a toner concentration detection sensor 35 measuring changes in permeability of the developer using the inductance of a coil and a replenishing developer is replenished from a replenishing developer container 15a according to the consumed amount of the toner. In addition, the toner concentration detection sensor 35 has the coil not shown in the drawing inside thereof.

A toner in the replenishing developer replenished into the developing device may not be supported on the surface of the magnetic carrier when the charge-imparting from the magnetic carrier is not quickly performed, and thus, an increase in a free toner may occur. Because erroneous detection of the toner concentration sensor may occur when the free toner is included, control of the T/C ratio may not be possible, and thus, a variety of defects may occur. That is, the defects may be facilitated in an image forming apparatus, in which the time required for the toner in the replenishing developer to reach a detection position of the toner concentration sensor after having been replenished to the developing device is not sufficiently long, and particularly, the defects may also be facilitated when an image forming device, in which a printing speed is fast by including a developing device having a narrow width corresponding to the width of A4 size paper, is used in a high-temperature and high-humidity environment.

However, in the image forming method of the present general inventive concept, because the foregoing two-component developer and the replenishing developer are used, charges are imparted to the toner in the supplied replenishing toner by the magnetic carrier in a relatively short time before being detected by the toner concentration detection sensor and the toner is supported on the surface of the magnetic carrier. Thus, highly productive printing of good images may be performed.

Four image forming units including the second image forming unit Pb, the third image forming unit Pc, and the fourth image forming unit Pd having color toners of different colors held in the respective developing devices and the same configuration as the first image forming unit Pa are installed in the present image forming apparatus. For example, a yellow toner, a magenta toner, a cyan toner, and a black toner are used in the first image forming unit Pa, the second image forming unit Pb, the third image forming unit Pc, and the fourth image forming unit Pd, respectively. Therefore, transfer of the each toner is sequentially performed from each transfer portion of the each image forming unit to the transfer material. Each toner image is superposed on the same transfer material by one movement of the transfer material while adjusting the registration of each superposed toner image in this process, and the transfer material is separated from the transfer material carrier 18 by a separation charger 19 after the process is finished. Thereafter, the transfer material is conveyed to a fixing device 20 by a conveying device such as a conveying belt and a final full-color image may be obtained by only a single fixing process. The fixing device 20 includes a fixing roller 21 and a pressing roller 22, and the fixing roller 21 has heating devices 25 and 26 inside thereof. An unfixed color toner image transferred to the transfer material is fixed on the transfer material by the action of heat and pressure by passing through a pressure contact portion of the fixing roller 21 and the pressing roller 22.

In FIG. 3, the transfer material carrier 18 is an endless belt-type member and the belt-type member moves in a direction of arrow (e direction) by a driving roller 30. In addition, the image forming apparatus includes a transfer belt cleaning device 29, a belt driven roller 31, a belt charge neutralizer 32, and a pair of registration rollers 33 for conveying the transfer material in a transfer material holder to the transfer material carrier 18. A contact transfer device, in which a transfer bias may be directly applied by abutting a transfer blade on the back side of the transfer material carrier 18 instead of using the transfer roller 14a abutting on the back side of the transfer material carrier 18, may be used as a transfer device. Also, instead of the foregoing contact transfer device, a non-contact transfer device transferring by being disposed without contact with the back side of the generally used transfer material carrier 18 and applying a transfer bias may be used.

The movement of the developer in the image forming apparatus using a replenishing developer will be described with reference to FIG. 4. As an electrostatic latent image on a photoreceptor is developed by a toner, the toner in a developing device 42 is consumed. The replenishing developer is supplied to the developing device 42 from a replenishing developer container 41 by detecting a decrease in the toner in the developing device by using a toner concentration detection sensor (not shown). Thereafter, excessive magnetic carriers in the developing device move to a developer recovery container 44. Also, the toner recovered from a cleaning device 43 may also be recovered in the developer recovery container 44.

In the developing device 42, a two-component developer is circulated between a supply port of the replenishing developer and a developing roller by a conveying member 47 having both stirring and mixing functions, such as an auger, for example, according to an operating state of the image forming apparatus, and the toner concentration detection sensor is installed in the middle of a circulation path.

The supplied replenishing developer is conveyed toward the developing roller while being stirred and mixed from the moment of being accommodated (initiation of supplying the replenishing developer) in the existing two-component developer being circulated, and a failure in detecting a toner concentration may occur in the case that the replenishing developer is not uniformly mixed before reaching the toner concentration detection sensor. Thus, this may be a cause of a variety of defects relating matching property or compatibility with the image forming apparatus.

In contrast, the image forming method of the present general inventive concept may form a good mixed state of the magnetic carrier and the toner even in the case that the time required from the initiation of supplying the replenishing developer to the arrival at the toner concentration detection sensor is short, for example within approximately 5 seconds, by using a two-component developer having rapid chargeability composed of the toner and the magnetic carrier formed by forming a coating layer optimizing the existence state of hydrotalcite and a polymer containing an acrylic monomer as a component on the surface of the magnetic carrier. Therefore, the image forming method of the present general inventive concept may contribute miniaturization or high speed of the image forming apparatus by preventing the foregoing defects in advance.

(Physical Property Measurement Methods)

Hereinafter, methods of measuring various physical properties according to the present general inventive concept will be described, but the present general inventive concept is not limited thereto.

<Method of Measuring Number-Average Particle Diameter (D1) of Hydrotalcite Particles or Inorganic Particles in Toner>

First, magnified photographs were taken from an object to be measured in order to measure a number-average particle diameter (D1) of hydrotalcite particles in a coating layer of a magnetic carrier or inorganic particles in a toner, and the image contrast was then adjusted so as to make the contour of an image of the object to be measured in the magnified photographs clear to obtain an image for measuring the number-average particle diameter. Thereafter, the image for measurement was appropriately magnified, and fifty or more of the object to be measured were then randomly selected and the major axes thereof were measured using a caliper or ruler to calculate the number-average particle diameters.

In the case that the hydrotalcite particles among the magnetic carrier particles were selected as the object to be measured, a cross section of the magnetic carrier particle was prepared by using a focused-ion beam machining apparatus “FB2200” (Hitachi, Ltd.) and a portion of the obtained cross section was observed at a magnification of approximately 15,000 times or more by using a scanning electron microscope “S-4700” (Hitachi, Ltd.). Also, inorganic particles in the toner were observed by using the scanning electron microscope with a magnification of approximately 30,000 times. Further, an energy dispersive X-ray analyzer attached to the scanning electron microscope was used to determine compositions of the objects to be measured.

<Measurement of Molar Ratio of Mg to Al Among Elements Constituting Hydrotalcite Particles>

A molar ratio of Mg to Al in the present general inventive concept may be determined by a typically known analysis method and for example, was measured by using an inductively coupled plasma optical emission spectrometer (ICP-OES) “SPS3500” (SII NanoTechnology Inc.).

Specifically, approximately 0.1 g of hydrotalcite particles were dissolved in approximately 5 ml of nitric acid, and the solution thus obtained was then distilled with ion-exchanged water to precisely prepare 100 ml of a solution for analysis. Then, contents of Al and Mg were measured and the molar ratio of Mg to Al was calculated.

<Content of Acrylic Component in Resin Component Constituting Coating Layer of Magnetic Carrier>

A content of an acrylic component in a resin component constituting a resin layer according to the present general inventive concept may be determined by combining a typically known technique of analyzing a polymer composition. For example, pyrolysis gas chromatography mass spectrometry (Py-GC/MS) using a Curie-point pyrolyzer, liquid chromatography mass spectrometry (LC/MS), nuclear magnetic resonance (NMR) spectrometry, elemental analysis, and infrared (IR) spectrometry were appropriately used as a specific analysis method. In particular, in the case of using Py-GC/MS, JIS K6231-1998 “Rubber—Identification of polymers (single polymers and blends)—Pyrolytic gas chromatographic method” was used as a reference.

<Methods of Measuring Weight-Average Particle Diameter (D4) of Toner Particles or a Toner, and Number of Particles Having a Diameter of Approximately 3 μm or Less in Particle Diameter Frequency Distribution Based on the Number>

A weight-average particle diameter (D4) of toner particles and a toner, and a particle diameter frequency distribution based on the number were measured by using, for example, a precision particle size distribution measurement instrument “Multisizer 3” (Beckman Coulter, Inc.) and were measured with reference to a “method of measuring a toner particle diameter distribution (http://www.beckmancoulterco.jp/product/product03/toner/04.html)” described in the website of Beckman Coulter, Inc. according to an operation manual of the measurement instrument.

In a specific measurement method, approximately 100 ml of an electrolyte “ISOTONE II PC” (Beckman Coulter, Inc) was prepared in a beaker for preparing a suspension and approximately 0.1 g of a surfactant (preferably, a linear alkylbenzen sulfonate (LAS)) was added and approximately 5 mg of a measurement sample (toner particles or toner) was added to prepare a toner suspension. Thereafter, in order to increase dispersion of the measurement sample in the toner suspension, an external ultrasonic irradiation treatment was performed for approximately 2 minutes by using an ultrasonic bath to prepare measurement samples.

An aperture tube having an opening diameter of approximately 50 μm was used to measure volume and the number of measurement samples for each channel to calculate a volume distribution and the number distribution of the measurement samples. The weight-average particle diameters of the measurement samples were obtained from the produced distribution.

<Shape Factor of Magnetic Carrier or Toner>

A shape factor ML²/A of the magnetic carrier or the toner according to the present general inventive concept was measured by using the following method.

First, a magnetic carrier and a toner were respectively observed at magnifications of approximately 1,000 times and approximately 3,000 times by using the scanning electron microscope “S-4700” (Hitachi, Ltd.) to obtain magnified photographs of measurement objects, and image contrasts were then adjusted so as to make the contours of images of the measurement objects in the magnified photographs clear to obtain images for measuring shape factors ML²/A. Fifty or more of the measurement objects were randomly selected and the images for measurement were accommodated in an image processor “LUZEX AP” (Nireco Corporation) according to an operation manual to obtain the shape factors ML²/A of the measurement objects.

<Amount of Tetrahydrofuran (THF) Soluble Fraction and Weight-Average Molecular Weight (M_{w}) Measured by Gel Permeation Chromatography (GPC)>

An amount (wt %) of THF soluble fraction or Mw in the resin component constituting the resin layer formed on the surface of the magnetic particle in the present general inventive concept was measured as below.

First, a resin component selected as a measurement sample was weighed, and dissolved/dispersed in THF to obtain a THF treated solution. Also, the dissolution/dispersion treatments were performed in an ultrasonic bath by external ultrasonic irradiation for approximately 5 minutes at room temperature. Thereafter, the THF treated solution thus obtained was filtrated by using a membrane filter (pore diameter; approximately 0.45 μm, Millipore Corporation) weighed in advance and dry weight of the membrane filter after the filtration treatment was measured to obtain an increased amount of the weight thereof (THF insoluble fraction). The increased amount of the weight was subtracted from the amount of the used measurement sample to determine the amount (wt %) of THF soluble fraction in the resin component.

Meanwhile, a filtrate obtained through the filtration process was used as a GPC measurement sample by adjusting a concentration of the resin component in the filtrate to be approximately 1 mg/ml. For the molecular weight measurement by GPC, HLC-8220 (Tosoh Corporation) including a differential refractive index detector (RI detector, RI-410, Waters Corporation) was used as a GPC measurement apparatus, and two TSKgel GMH_{XL} and one TSKgel G2500H_{XL} were connected to a TSKguar column to be used as a measurement column (all measurement columns were products of Tosoh Corporation). As measurement conditions, a column temperature was approximately 23° C., a flow rate of THF, an eluent, was approximately 1.0 ml/min., and a dosage of the measurement sample was approximately 200 μl.

Also, in order to draw a calibration curve representing a “relationship between elution time and molecular weight”, TSK standard polystyrene (Tosoh Corporation) was appropriately used as a standard polystyrene to determine the Mw (polystyrene (PS) equivalent) of the resin component constituting the resin layer according to the present general inventive concept.

### EXAMPLES

Hereinafter, the present general inventive concept will be described in more detail according to specific preparation examples and examples, but the present general inventive concept is not limited thereto.

### Preparation Example 1 of Magnetic Carrier

### Preparation of Magnetic Particles

Magnetic particles composed of ferrite having a manganese (Mn) content of approximately 21.0 mol % in terms of MnO, a magnesium (Mg) content of approximately 3.3 mol % in terms of MgO, a strontium (Sr) content of approximately 0.7 mol % in terms of SrO, and an iron (Fe) content of approximately 75.0 mol % in terms of Fe₂O₃ was prepared by the following sequence.

Commercial MnCO₃, Mg(OH)₂, SrCO₃, and Fe₂O₃ were appropriately mixed to allow each content of Mn, Mg, Sr, and Fe to be the foregoing values, water is then added thereto, and milling and mixing were performed by using a ball mill (Seiwa Giken Co., Ltd.) for approximately 10 hours. Firing was performed at approximately 950° C. for approximately 4 hours after milling and mixing to prepare calcined ferrite.

The calcined ferrite was crushed and then, water was again added to prepare a ferrite slurry by ball milling for approximately 24 hours. Approximately 2 parts by weight of polyvinyl alcohol based on 100 parts by weight of the obtained ferrite slurry was added, and appropriate amounts of silica particles and an ammonium salt of polycarboxylic acid as dispersants were added to stabilize a state of dispersion. Then, granulation and drying were performed by using a spray dryer (Ohkawara Kakohki Co., Ltd.) to prepare spherical particles having a diameter of approximately 43 μm.

The spherical particles thus obtained were fired at approximately 1100° C. for approximately 4 hours in a nitrogen atmosphere, and agglomerated particles were then disintegrated and screened to remove coarse particles and thus, magnetic particles were obtained.

### Preparation Example of Magnetic Carrier

### Preparation of Hydrotalcite Particles

Synthetic hydrotalcite particles (Kyowa Chemical Industry Co., Ltd.) were milled by using a jet mill (Hosokawa Micron Group) to prepare hydrotalcite particles HT-1 to HT-6 having different number-average particle diameters. The results thereof are summarized and presented in Table 1.

TABLE 1

| | Number-average particle | |
|---|---|---|
| Hydrotalcite particles | diameter (μm) | Mg/Al (molar ratio) |
| HT-1 | 0.35 | 2.10 |
| HT-2 | 0.12 | 2.10 |
| HT-3 | 0.55 | 2.01 |
| HT-4 | 0.39 | 0.75 |
| HT-5 | 0.41 | 3.17 |
| HT-6 | 0.05 | 0.75 |

### Preparation of Resin Solution 1 for Coating Magnetic Particles

Approximately 20 parts by weight of a methyl methacrylate (MMA)/styrene (St) copolymer (molar ratio: 84/16) as a resin component constituting a coating layer of the magnetic particles were dissolved in approximately 2,000 parts by weight of toluene, and approximately 2 parts by weight of carbon black (Cabot Corporation) (approximately 10 parts by weight based on the resin for coating magnetic particles) and approximately 2 parts by weight of hydrotalcite particles “HT-1” listed in Table 1 (approximately 10 parts by weight based on the resin for coating magnetic particles) were dispersed by using a T.K. HOMO DISPER (Primix Corporation) to obtain Resin Solution 1 for coating magnetic particles.

### Preparation of Resin Solution 2 for Coating Magnetic Particles

Resin Solution 2 for coating magnetic particles was obtained in the same manner as in “Preparation of Resin Solution 1 for Coating Magnetic Particles” except that approximately 16 parts by weight of a MMA/St copolymer (molar ratio: 98/2) and approximately 4 parts by weight of an isobutyl methacrylate (IBMA)/St copolymer (molar ratio: 60/40) were used as a resin component and an amount of hydrotalcite particles “HT-1” added was changed to approximately 3 parts by weight.

### Preparation of Resin Solution 3 for Coating Magnetic Particles

Resin Solution 3 for coating magnetic particles was obtained in the same manner as in “Preparation of Resin Solution 1 for Coating Magnetic Particles” except that a MMA/St/divinylbenzene (DVB) copolymer (molar ratio: 69/30.998/0.002) was used as a resin component and an amount of hydrotalcite particles “HT-1” added was changed to approximately 6 parts by weight (approximately 30 parts by weight based on the resin for coating magnetic particles).

### Preparation of Resin Solution 4 for Coating Magnetic Particles

Resin Solution 4 for coating magnetic particles was obtained in the same manner as in “Preparation of Resin Solution 1 for Coating Magnetic Particles” except that approximately 17 parts by weight of a MMA/St copolymer (molar ratio: 90/10) and approximately 3 parts by weight of a tert-butyl methacrylate (TBMA)/St copolymer (molar ratio: 20/80) were used as a resin component and an amount of hydrotalcite particles “HT-1” added was changed to approximately 0.6 parts by weight (approximately 3 parts by weight based on the resin for coating magnetic particles).

### Preparation of Resin Solution 5 for Coating Magnetic Particles

Resin Solution 5 for coating magnetic particles was obtained in the same manner as in “Preparation of Resin Solution 1 for Coating Magnetic Particles” except that approximately 17 parts by weight of a MMA/St copolymer (molar ratio: 93/7) and approximately 3 parts by weight of a sec-butyl methacrylate (SBMA)/St copolymer (molar ratio: 35/65) were used as a resin component and an amount of hydrotalcite particles “HT-1” added was changed to approximately 6 parts by weight (approximately 30 parts by weight based on the resin for coating magnetic particles).

### Preparation of Resin Solution 6 for Coating Magnetic Particles

Resin Solution 6 for coating magnetic particles was obtained in the same manner as in “Preparation of Resin Solution 1 for Coating Magnetic Particles” except that approximately 20 parts by weight of a MMA/St copolymer (molar ratio: 86/14) was used as a resin component and an amount of hydrotalcite particles “HT-1” added was changed to approximately 0.2 parts by weight (approximately 1 part by weight based on the resin for coating magnetic particles).

### Preparation of Resin Solution 7 for Coating Magnetic Particles

Resin Solution 7 for coating magnetic particles was obtained in the same manner as in “Preparation of Resin Solution 1 for Coating Magnetic Particles” except that a MMA/St copolymer (molar ratio: 79/21) was used as a resin component and an amount of hydrotalcite particles “HT-1” added was changed to approximately 7 parts by weight (approximately 35 parts by weight based on the resin for coating magnetic particles).

### Preparation of Resin Solution 8 for Coating Magnetic Particles

Resin Solution 8 for coating magnetic particles was obtained in the same manner as in “Preparation of Resin Solution 1 for Coating Magnetic Particles” except that a MMA/St copolymer (molar ratio: 99/1) was used as a resin component and an amount of hydrotalcite particles “HT-1” added was changed to approximately 3 parts by weight (approximately 15 parts by weight based on the resin for coating magnetic particles).

### Preparation of Resin Solution 9 for Coating Magnetic Particles

Resin Solution 9 for coating magnetic particles was obtained in the same manner as in “Preparation of Resin Solution 1 for Coating Magnetic Particles” except that a MMA/St copolymer (molar ratio: 70/30) was used as a resin component and an amount of hydrotalcite particles “HT-1” added was changed to approximately 3 parts by weight (approximately 15 parts by weight based on the resin for coating magnetic particles).

### Preparation of Resin Solution 10 for Coating Magnetic Particles

Resin Solution 10 for coating magnetic particles was obtained in the same manner as in “Preparation of Resin Solution 1 for Coating Magnetic Particles” except that a MMA/St/DVB copolymer (molar ratio: 99/0.995/0.005) was used as a resin component and an amount of hydrotalcite particles “HT-1” added was changed to approximately 0.4 parts by weight (approximately 2 parts by weight based on the resin for coating magnetic particles).

### Preparation of Resin Solution 11 for Coating Magnetic Particles

Resin Solution 11 for coating magnetic particles was obtained in the same manner as in “Preparation of Resin Solution 1 for Coating Magnetic Particles” except that approximately 15 parts by weight of a MMA/St copolymer (molar ratio: 95/5) and approximately 5 parts by weight of a silicone resin (Dow Corning Toray Co., Ltd.) in terms of a solids content were used as a resin component and an amount of hydrotalcite particles “HT-1” added was changed to approximately 30 parts by weight.

### Preparation of Resin Solution 12 for Coating Magnetic Particles

Resin Solution 12 for coating magnetic particles was obtained in the same manner as in “Preparation of Resin Solution 11 for Coating Magnetic Particles” except that an amount of the MMA/St copolymer and an amount of the silicone resin in terms of a solids content were changed to approximately 13 parts by weight and approximately 7 parts by weight, respectively.

### Preparation Example 1 of Magnetic Carrier

Resin Solution 1 for coating magnetic particles obtained from “Preparation of Resin Solution 1 for Coating Magnetic Particles” was coated so as to allow the resin component to be approximately 2 parts by weight based on 100 parts by weight of the magnetic particles obtained from “Preparation of Magnetic Particles” by using SPIRA COTA (Okada Seiko Co., Ltd.) in a heating environment at approximately 70° C., and was heated at approximately 100° C. for approximately 5 hours to remove toluene.

Thereafter, coarse particles were removed through a screen having a mesh size of approximately 75 μm by using a sieve shaker (Koei Sangyo Co., Ltd.) to obtain Magnetic Carrier 1.

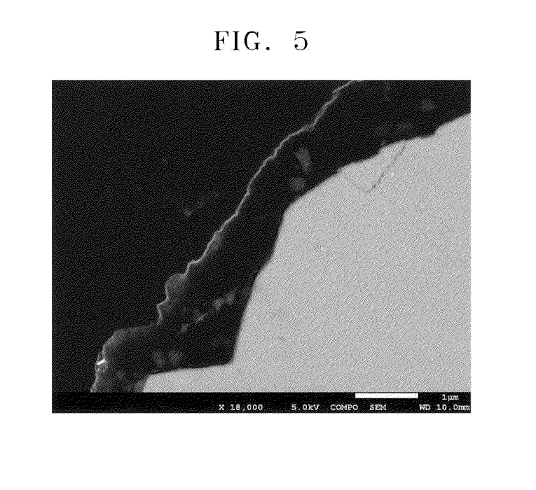

A shape factor ML²/A of the obtained Magnetic Carrier 1 was approximately 115 and a median particle diameter (D50) based on volume distribution was approximately 43 μm. According to the observation of appearances and cross sections of the magnetic carrier particles by the scanning electron microscope, it was confirmed that smooth resin layers were formed on the surfaces of the particles and hydrotalcite particles having a number-average particle diameter of approximately 0.35 μm were uniformly distributed in the resin layer (see FIG. 5).

Also, as a result of the analysis of the resin component constituting the resin layer, a THF soluble fraction was approximately 100 wt % and a weight-average molecular weight was approximately 39,700.

### Preparation Examples 2 to 12 of Magnetic Carrier

Magnetic Carriers 2 to 12 were obtained in the same manner as in “Preparation Example 1 of Magnetic Carrier” except that Resin Solutions 2 to 12 for coating magnetic particles obtained from “Preparation of Resin Solutions 2 to 12 for Coating Magnetic Particles” were used instead of Resin Solution 1 for coating magnetic particles.

The results of the obtained Magnetic Carriers 2 to 12 are summarized and presented in the following Table 2. Also, because the silicone resin was used together with the acrylic resin as resin components constituting the resin layers of Magnetic Carriers 11 and 12, measurements of THF soluble fractions and weight-average molecular weights in coating layers of the surfaces of the magnetic carriers were difficult. Further, they correspond to cases of jointly using “other resin” in addition to the acrylic resin, a correction value was used for a content of the acrylic monomer unit C_{A} with respect to the total monomer unit of the resin component constituting the coating layer.

TABLE 2

| | | Prep. | Prep. | Prep. | Prep. | Prep. | Prep. | Prep. | Prep. | Prep. | Prep. | Prep. | Prep. |
|---|---|---|---|---|---|---|---|---|---|---|---|---|---|
| | | Exam- | Exam- | Exam- | Exam- | Exam- | Exam- | Exam- | Exam- | Exam- | Exam- | Exam- | Exam- |
| Preparation Example | | ple | ple | ple | ple | ple | ple | ple | ple | ple | ple | ple | ple |
| of magnetic carrier | | 1 | 2 | 3 | 4 | 5 | 6 | 7 | 8 | 9 | 10 | 11 | 12 |
| Resin solution for coating | | Resin | Resin | Resin | Resin | Resin | Resin | Resin | Resin | Resin | Resin | Resin | Resin |
| magnetic particles | | Solu- | Solu- | Solu- | Solu- | Solu- | Solu- | Solu- | Solu- | Solu- | Solu- | Solu- | Solu- |
| | | tion | tion | tion | tion | tion | tion | tion | tion | tion | tion | tion | tion |
| | | 1 | 2 | 3 | 4 | 5 | 6 | 7 | 8 | 9 | 10 | 11 | 12 |
| Magnetic carrier obtained | | Mag- | Mag- | Mag- | Mag- | Mag- | Mag- | Mag- | Mag- | Mag- | Mag- | Mag- | Mag- |
| | | netic | netic | netic | netic | netic | netic | netic | netic | netic | netic | netic | netic |
| | | Carrier | Carrier | Carrier | Carrier | Carrier | Carrier | Carrier | Carrier | Carrier | Carrier | Carrier | Carrier |
| | | 1 | 2 | 3 | 4 | 5 | 6 | 7 | 8 | 9 | 10 | 11 | 12 |
| Resin | Resin | MMA/ | MMA/ | MMA/ | MMA/ | MMA/ | MMA/ | MMA/ | MMA/ | MMA/ | MMA/ | MMA/ | MMA/ |
| layer | component | St Co. | St Co. | St/DVB | St Co. | St Co. | St Co. | St Co. | St Co. | St Co. | St/DVB | St Co. | St Co. |
| on | of resin | | IBMA/ | Co. | TBMA/ | | SBMA/ | | | | Co. | silicone | silicone |
| carrier | layer | | St Co. | | St Co. | | St Co. | | | | | resin | resin |
| surface | Acrylic | 100 | 100 | 100 | 100 | 100 | 100 | 100 | 100 | 100 | 100 | 75 | 65 |
| | resin | | | | | | | | | | | | |
| | content | | | | | | | | | | | | |
| | (wt %) | | | | | | | | | | | | |
| | Acryl | 84 | 92 | 69 | 80 | 87 | 86 | 79 | 99 | 70 | 99 | 90 | 90 |
| | monomer | | | | | | | | | | | | |
| | unit content | | | | | | | | | | | | |
| | C_{A} (mol %) | | | | | | | | | | | | |
| | Hydrotalcite | 10 | 3 | 30 | 3 | 30 | 1 | 35 | 15 | 15 | 2 | 30 | 30 |
| | content | | | | | | | | | | | | |
| | C_{H} | | | | | | | | | | | | |
| | (parts by | | | | | | | | | | | | |
| | weight) | | | | | | | | | | | | |
| | C_{H} × 0.38 + C_{A} | 88 | 93 | 80 | 81 | 98 | 86 | 92 | 105 | 76 | 100 | 79 | 70 |
| | Amount of | 100 | 100 | 95 | 100 | 100 | 100 | 100 | 100 | 100 | 88 | N.A. | N.A. |
| | THF | | | | | | | | | | | | |
| | soluble | | | | | | | | | | | | |
| | fraction | | | | | | | | | | | | |
| | (wt %) | | | | | | | | | | | | |
| | Weight- | 39,700 | 47,800 | 264,600 | 43,500 | 37,100 | 41,100 | 41,000 | 40,800 | 43,700 | 563,900 | N.A. | N.A. |
| | average | | | | | | | | | | | | |
| | molecluar | | | | | | | | | | | | |
| | weight | | | | | | | | | | | | |
| | (M_{W}) of | | | | | | | | | | | | |
| | THF | | | | | | | | | | | | |
| | soluble | | | | | | | | | | | | |
| | fraction | | | | | | | | | | | | |
| Charac- | Surface | Smooth | Smooth | Minor | Smooth | Smooth | Smooth | Minor | Smooth | Smooth | Uneven- | Uneven- | Uneven- |
| teristics | appearance | | | uneven- | | | | uneven- | | | ess | ess | ess |
| | of resin | | | ess | | | | ess | | | | | |
| | layer | | | | | | | | | | | | |
| | Shape | 115 | 113 | 120 | 115 | 111 | 114 | 122 | 114 | 112 | 129 | 135 | 136 |
| | factor | | | | | | | | | | | | |
| | ML²/A | | | | | | | | | | | | |
| | Median | 43 | 43 | 43 | 43 | 43 | 43 | 43 | 43 | 43 | 43 | 43 | 43 |
| | particle | | | | | | | | | | | | |
| | diameter | | | | | | | | | | | | |
| | (D50) (μm) | | | | | | | | | | | | |

Co.: Copolymer

Minor unevenness: Occurrence of minor unevenness in a portion

Unevenness: Occurrence of unevenness

### Preparation Example of Toner

### Preparation Example 1 of Toner Particles

The following components were dry mixed by using a Henschel mixer (Nippon Coke & Engineering Co., Ltd.) and kneading was then performed by using a twin screw kneader (Ikegai Corporation).
Binder resin (polyester resin: Mw=50,000, Tg: 60° C.): 100 parts by weight
Carbon black (average particle diameter: 40 nm): 5 parts by weight
Al compound formed of a salicylic acid derivative (Orient Chemical Industries Co., Ltd.): 1 part by weight
Ester wax (peak temperature of maximum endothermic peak by DSC: 90° C.): 5 parts by weight.

The obtained mixture was cooled and was subjected to rough milling to obtain a particle diameter of approximately 1 mm or less, and fine milling was then performed by using a mechanical milling machine (Freund-Turbo Corporation). The milled product was classified by using an ELBOW-JET classifier (Nittetsu Mining Co., Ltd.) and a granulation treatment was performed by using a Nara Hybridization System (Nara machinery Co., Ltd.). Then, classification was again performed to obtain Toner Particle 1 in which a weight-average particle diameter (D4) was approximately 6.0 μm, the number of toner particles having a diameter of approximately 3 μm or less was approximately 3.5 number % (hereinafter, simply abbreviated as “%”) in a particle diameter frequency distribution based on the number, and a shape factor ML²/A of the toner particles was approximately 132.

### Preparation Examples 2 to 5 of Toner Particles

Toner Particle 2 to 5 having different weight-average particle diameters or shape factors ML²/A were obtained in the same manner as “Preparation Example 1 of Toner Particles” except that operating conditions of the mechanical milling machine, the Nara Hybridization System, and the ELBOW-JET classifier were changed.

### Preparation Example 1 of Toner

The following components were introduced into the Henschel mixer and preliminary mixing was performed at a circumferential speed of approximately 16 m/sec for approximately 1 minute, and dry mixing was then performed at a circumferential speed of approximately 40 m/sec for approximately 4 minutes.
Toner Particle 1 obtained from “Preparation Example 1 of Toner Particles”: 100 parts by weight
Hydrophobically treated fine titania particles (number-average particle diameter: approximately 0.03 μm): 1.0 part by weight.

The following components were introduced into the obtained mixture after the first dry mixing, and second dry mixing was performed for approximately 4 minutes.

Silicone oil-treated fine silica particles (number-average particle diameter: approximately 0.03 μm, treated amount of the oil: 5 parts by weight): 1.5 parts by weight

Hydrophobically treated fine silica particles (number-average particle diameter: approximately 0.02 μm): 0.5 parts by weight

Fine zinc stearate particles (number-average particle diameter: approximately 7.9 μm): 0.1 parts by weight

Fine cerium oxide particles (number-average particle diameter: approximately 0.65 μm): 0.3 parts by weight.

Sieving was performed after the second dry mixing to remove coarse particles and Toner B1 was obtained.

Toner B1 obtained had a weight-average particle diameter (D4) of approximately 6.0 μm, the number of toner particles having a diameter of approximately 3 μm or less of approximately 3.5% in a particle diameter frequency distribution based on the number, and a shape factor ML²/A of approximately 132. A content of fine inorganic particles having a number-average particle diameter ranging from approximately 0.01 μm or more to approximately 0.15 μm or less was approximately 3.0 parts by weight based on 100 parts by weight of the toner particles.

### Preparation Example 2 of Toner

Toner B2 was obtained in the same manner as in “Preparation Example 1 of Toner” except that 1.5 parts by weight of hydrophobically treated fine silica particles (number-average particle diameter: approximately 0.05 μm) was used instead of the silicone oil-treated fine silica particles.

### Preparation Examples 3 to 6 of Toners

Toners B3 to B6 were obtained in the same manner as in “Preparation Example 2 of Toner” except that Toner Particle 1 was changed to “Toner Particle 3 to 6”.

Toners B1 to B6 thus obtained are summarized and presented in the following Table 3.

TABLE 3

| | | | | The number of | | In fine inorganic | |
|---|---|---|---|---|---|---|---|
| | | | | toner particles | | particles having a | |
| | | | | having a | | diameter ranging | |
| | | | | diameter of | | from approximately | |
| | | | | approximately | | 0.01 μm or more to | |
| | | | | 3μm or less in | | approximately 0.15 | |
| | | | | a particle | | μm or less | |
| | | | | diameter | | | Presence |
| | | | Weight- | frequency | | | of silicon- |
| | | | average | distribution | | Content | oil treated |
| Preparation | | Toner | particle | based on the | Shape | (parts | fine |
| Example of | Toner | particles | diameter | number | factor | by | inorganic |
| toner | obtained | used | (μm) | (number %) | ML²/A | weight) | particles |
| Prep. | Toner | Toner | 6.0 | 3.5 | 132 | 3.0 | present |
| Example 1 | B1 | Particle | | | | | |
| of toner | | 1 | | | | | |
| Prep. | Toner | Toner | 6.0 | 3.5 | 132 | 3.0 | absent |
| Example 2 | B2 | Particle | | | | | |
| of toner | | 1 | | | | | |
| Prep. | Toner | Toner | 7.8 | 3.7 | 140 | 3.0 | absent |
| Example 3 | B2 | Particle | | | | | |
| of toner | | 2 | | | | | |
| Prep. | Toner | Toner | 5.8 | 5.8 | 121 | 3.0 | absent |
| Example 4 | B4 | Particle | | | | | |
| of toner | | 3 | | | | | |
| Prep. | Toner | Toner | 7.5 | 5.5 | 152 | 3.0 | absent |
| Example 5 | B5 | Particle | | | | | |
| of toner | | 4 | | | | | |
| Prep. | Toner | Toner | 8.8 | 7.0 | 165 | 3.0 | absent |
| Example 6 | B6 | Particle | | | | | |
| of toner | | 5 | | | | | |

### Example 1

A remodeled apparatus was used as an image forming apparatus, in which a charger in a charging device of a SAMSUNG SCX-8040 ND monochrome multifunction printer (Samsung Electronics Co., Ltd.) corresponding to A3 size paper was changed into a charging roller type being used by contacting with latent image carriers and a printing speed was also increased to approximately 45 sheets/minute (A4 size papers were printed in a transverse direction).

A two-component developer prepared by mixing Toner B1 obtained from “Preparation Example 1 of Toner” and Magnetic Carrier 13 obtained from “Preparation Example 13 of Magnetic Carrier” so as to allow T/C thereof to be approximately 7% was introduced into a developing unit of the image forming apparatus as a developer for start, and Toner B1 not combined with magnetic carriers was used as a replenishing developer.

Image output tests were carried out by printing out 100,000 sheets in a high-temperature and high-humidity environment (approximately 30° C./85% RH) and a low-temperature and low-humidity environment (approximately 15° C./10% RH), and image quality of the obtained images were then evaluated and matching property of the image forming apparatus with the two-component developer was also evaluated. Also, full color copier paper C2 (approximately 70 g/cm³, A4 size) by Fuji Xerox Co., Ltd. was used as a transfer material.

Hereinafter, evaluation of image quality of the printed images and evaluation of matching property of the image forming apparatus with the two-component developer will be described in detail.

[1. Image Density]

An image having square solid patches (one side of approximately 5 mm) near four corners and at a center position was printed out and reflection densities of the solid patches were measured by using a SpectroEye (Gretag-Macbeth, AG) and an average value of the measured values was calculated and evaluated according to the following criteria.

A: 1.3 or more (very good)

B: 1.15 or more and less than 1.30 (good)

C: 1.00 or more and less than 1.15 (acceptable level in the present general inventive concept)

D: less than 1.00 (unacceptable level in the present general inventive concept)

[2. Reproducibility of Small-Point Character Image]

Five-points character images were printed out near the four corners and at the center position and reproducibility of the obtained character images was evaluated according to the following criteria.

A: changes in a line width of fine lines were less than 10% (very good)

B: changes in a line width of fine lines were 10% or more and less than 20% (good)

C: changes in a line width of fine lines were 20% or more and can also be confirmed easily by the naked eye (acceptable level in the present general inventive concept).

D: breakages in fine lines can also be confirmed by the naked eye (unacceptable level in the present general inventive concept)

[3. Background Fogging]

During the formation of a solid white image, toners present on a photoreceptor drum were adhered to an adhesive side of a Mending tape (Registered Trademark, Sumitomo 3M, Ltd.) while shifting to a transfer process after a developing process, and a reflection density of a paper having the Mending tape with the toners attached thereon was measured by using SpectroEye (Gretag-Macbeth, AG). A value obtained by subtracting a reflection density (blank) of the same paper having the Mending tape as it is without the toners attached thereon from the obtained reflection density was calculated and evaluated according to the following criteria.

A: less than 0.03 (very good)

B: 0.03 or more and less than 0.07 (good)

C: 0.07 or more and less than 1.00 (acceptable level in the present general inventive concept)

D: 1.00 or more (unacceptable level in the present general inventive concept)

[4. Toner Scattering]

After image printing was terminated in a high-temperature and high-humidity environment, toner scattering was evaluated according to the following criteria.

A: toner scattering around the image forming unit was insignificant (very good)

B: toner scattering around the image forming unit occurred, but toner scattering did not reach an exterior of the image forming apparatus near the image forming unit (good)

C: toner scattering reached the exterior of the image forming apparatus near the image forming unit (acceptable level in the present general inventive concept)

D: scattered toner was accumulated in a dead space around the image forming unit (unacceptable level in the present general inventive concept)

[5. Image Shade Stain due to Charging Roller]

After image printing was terminated in a low-temperature and low-humidity environment, a halftone image composed of halftone dots was printed out and a shade stain having the shape of a transverse streak appeared in the period of a circumferential length of the charging roller used was observed by the naked eye in the obtained halftone image and evaluated according to the following criteria.

A: a shade stain having the shape of a transverse streak cannot be confirmed (very good)

B: a very minor shade stain having the shape of a transverse streak occurs in a degree that is confirmable by observation with a magnifying glass (good)

C: a minor shade stain having the shape of a transverse streak occurs (acceptable level in the present general inventive concept)

D: two or more of shade stains having the shape of a transverse streak occurs (unacceptable level in the present general inventive concept)

As a result of the evaluation tests performed according the foregoing, good results were obtained for each evaluation item. The details of the evaluation results are summarized and presented in the following Table 4.

### Example 2

An evaluation test was performed in the same manner as in “Example 1” except that Toner B2 obtained from “Preparation Example 2 of Toner” was used.

### Example 3

An evaluation test was performed in the same manner as in “Example 2” except that Magnetic Carrier 2 obtained from “Preparation Example 2 of Magnetic Carrier” was used.

### Example 4

An evaluation test was performed in the same manner as in “Example 2” except that Magnetic Carrier 3 obtained from “Preparation Example 3 of Magnetic Carrier” was used.

### Example 5

An evaluation test was performed in the same manner as in “Example 2” except that Magnetic Carrier 4 obtained from “Preparation Example 4 of Magnetic Carrier” was used.

### Example 6

An evaluation test was performed in the same manner as in “Example 2” except that magnetic Carrier 5 obtained from “Preparation Example 5 of Magnetic Carrier” was used.

### Example 7

An evaluation test was performed in the same manner as in “Example 1” except that Magnetic Carrier 4 obtained from “Preparation Example 4 of Magnetic Carrier” and Toner B3 obtained from “Preparation Example 3 of Toner” were used.

### Example 8

An evaluation test was performed in the same manner as in “Example 1” except that Toner B4 obtained from “Preparation Example 4 of Toner” was used.

### Example 9

An evaluation test was performed in the same manner as in “Example 1” except that Toner B5 obtained from “Preparation Example 5 of Toner” was used.

### Example 10

An evaluation test was performed in the same manner as in “Example 1” except that Toner B6 obtained from “Preparation Example 6 of Toner” was used.

### Example 11

An evaluation test was performed in the same manner as in “Example 2” except that Magnetic Carrier 11 obtained from “Preparation Example 11 of Magnetic Carrier” was used.

The evaluation results of “Examples 2 to 11” are summarized and presented in the following Table 4.

TABLE 4

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple | ple | ple | ple | ple | ple | ple | ple | ple | ple | ple |
| | | | 1 | 2 | 3 | 4 | 5 | 6 | 7 | 8 | 9 | 10 | 11 |
| Magnetic carrier used | | | Mag- | Mag- | Mag- | Mag- | Mag- | Mag- | Mag- | Mag- | Mag- | Mag- | Mag- |
| | | | netic | netic | netic | netic | netic | netic | netic | netic | netic | netic | netic |
| | | | Carrier | Carrier | Carrier | Carrier | Carrier | Carrier | Carrier | Carrier | Carrier | Carrier | Carrier |
| | | | 1 | 1 | 2 | 3 | 4 | 5 | 4 | 4 | 4 | 4 | 11 |
| Toner used | | | Toner | Toner | Toner | Toner | Toner | Toner | Toner | Toner | Toner | Toner | Toner |
| | | | B1 | B2 | B2 | B2 | B2 | B2 | B4 | B4 | B4 | B4 | B11 |
| Magnitude of shape factor ML²/A of | | | Small | Small | Small | Small | Small | Small | Small | Small | Small | Small | Large |
| magnetic carrier with respect to toner | | | | | | | | | | | | | |
| Presence of silicone-oil treated fine | | | Present | Present | Present | Present | Present | Present | Absent | Absent | Absent | Absent | Absent |
| inorganic particles in fine inorganic | | | | | | | | | | | | | |
| particles having a diameter ranging | | | | | | | | | | | | | |
| from approximately 0.01 μm or more | | | | | | | | | | | | | |
| to approximately 0.15 μm or less | | | | | | | | | | | | | |
| Image | High- | Image | A | A | B | B | C | B | C | C | C | C | C |
| quality | temper- | density | | | | | | | | | | | |
| evalua | ature | Reproducibility | A | B | C | C | C | B | C | C | C | C | C |
| tion- | and | of small | | | | | | | | | | | |
| | high- | point | | | | | | | | | | | |
| | humid- | character | | | | | | | | | | | |
| | ity | image | | | | | | | | | | | |
| | | Background | A | A | B | B | C | B | C | C | C | C | C |
| | | fogging | | | | | | | | | | | |
| | [symbol] | Image | A | A | B | C | B | C | B | B | B | C | C |
| | ature | density | | | | | | | | | | | |
| | and | Reproducibility | A | A | B | C | B | C | C | B | C | C | C |
| | [symbol] | of small | | | | | | | | | | | |
| | | point | | | | | | | | | | | |
| | | character | | | | | | | | | | | |
| | | image | | | | | | | | | | | |
| | | Background | A | A | B | B | C | C | C | C | C | C | C |
| | | fogging | | | | | | | | | | | |

| | | | | | | | | | | | | |
|---|---|---|---|---|---|---|---|---|---|---|---|---|
| Matching property | Toner | A | B | C | B | C | B | C | C | C | C | C |
| of Image forming | scattering | | | | | | | | | | | |
| apparatus | Image shade | A | A | B | C | B | C | B | C | C | C | C |
| | stain due to | | | | | | | | | | | |
| | charging | | | | | | | | | | | |
| | roller | | | | | | | | | | | |

[symbol]

indicates data missing or illegible when filed

### Comparative Example 1

An evaluation test was performed in the same manner as in “Example 2” except that magnetic Carrier 6 obtained from “Preparation Example 6 of Magnetic Carrier” was used.

As a result, because an amount of added hydrotalcite particles in the coating layer formed on the surface of the magnetic carrier was small, charge-imparting ability to the toner was not sufficient and particularly, image formation in a high-temperature and high-humidity environment and matching property with the image forming apparatus were inhibited.

### Comparative Example 2

An evaluation test was performed in the same manner as in “Example 2” except that magnetic Carrier 7 obtained from “Preparation Example 7 of Magnetic Carrier” was used.

As a result, because an amount of added hydrotalcite particles in the coating layer formed on the surface of the magnetic carrier was large, charge-imparting ability was excessive and particularly, image formation in a low-temperature and low-humidity was inhibited. Also, defects, such as peeling of a surface resin of the magnetic carrier, also occurred.

### Comparative Example 3

An evaluation test was performed in the same manner as in “Example 2” except that magnetic Carrier 8 obtained from “Preparation Example 8 of Magnetic Carrier” was used. However, satisfactory image formation and matching property with the image forming apparatus were not obtained.

### Comparative Example 4

An evaluation test was performed in the same manner as in “Example 2” except that magnetic Carrier 9 obtained from “Preparation Example 9 of Magnetic Carrier” was used. However, satisfactory image formation and matching property with the image forming apparatus were not obtained.

### Comparative Example 5

An evaluation test was performed in the same manner as in “Example 2” except that magnetic Carrier 10 obtained from “Preparation Example 10 of Magnetic Carrier” was used. However, satisfactory image formation and matching property with the image forming apparatus were not obtained.

### Comparative Example 6

An evaluation test was performed in the same manner as in “Example 2” except that magnetic Carrier 12 obtained from “Preparation Example 12 of Magnetic Carrier” was used.

As a result, because a content of an acrylic resin in the resin layer formed on the surface of the magnetic carrier was small, the effect of adding the hydrotalcite particles was not sufficiently obtained and particularly, image formation in a high-temperature and high-humidity environment and matching property with the image forming apparatus were inhibited.

The evaluation results of “Comparative Examples 1 to 6” are summarized and presented in the following Table 5.

TABLE 5

| | | | Comparative | Comparative | Comparative | Comparative | Comparative | Comparative |
|---|---|---|---|---|---|---|---|---|
| | | | Example | Example | Example | Example | Example | Example |
| | | | 1 | 2 | 3 | 4 | 5 | 6 |
| Magnetic carrier used | | | Magnetic | Magnetic | Magnetic | Magnetic | Magnetic | Magnetic |
| | | | Carrier 6 | Carrier 7 | Carrier 8 | Carrier 9 | Carrier 10 | Carrier 12 |
| Toner used | | | Toner B11 | Toner B11 | Toner B11 | Toner B11 | Toner B11 | Toner B11 |
| Magnitude of shape factor | | | Small | Small | Small | Small | Small | Large |
| ML²/A of magnetic carrier | | | | | | | | |
| with respect to toner | | | | | | | | |
| Presence of silicone-oil treated | | | Absent | Absent | Absent | Absent | Absent | Absent |
| fine inorganic particles in fine | | | | | | | | |
| inorganic particles having a | | | | | | | | |
| diameter ranging from | | | | | | | | |
| approximately 0.01 μm or more | | | | | | | | |
| to approximately 0.15 μm or less | | | | | | | | |
| Image | High- | Image density | D | C | C | D | C | D |
| quality | temer- | Reproducibility | D | C | C | D | C | D |
| evalua- | ature | of small point | | | | | | |
| tion | and | character image | | | | | | |
| | high- | Background | D | D | C | D | C | D |
| | humid- | fogging | | | | | | |
| | ity | | | | | | | |
| | Low- | Image density | C | C | D | C | B | C |
| | temper- | Reproducibility | D | D | D | D | B | D |
| | ature | of small point | | | | | | |
| | and | character image | | | | | | |
| | low- | Background | C | B | B | C | C | C |
| | humid- | fogging | | | | | | |
| | ity | | | | | | | |

| | | | | | | | |
|---|---|---|---|---|---|---|---|
| Matching property | Toner scattering | D | C | C | D | C | D |
| of Image forming | Image shade | C | D | B | C | D | D |
| apparatus | stain due to | | | | | | |
| | charging roller | | | | | | |

### Preparation Example 13 of Magnetic Carrier

A mixture formed of the following components was dispersed by using T.K. HOMO DISPER (Primix Corporation) and a resin solution for coating magnetic particles dispersing hydrotalcite particles was prepared.

Resin component (MMA/St copolymer, molar ratio: 84/16): 100 parts by weight

Hydrotalcite particles “HT-1” listed in the foregoing Table 1: 10 parts by weight

Conductive particles (Carbon Black: product of Cabot Corporation): 7.5 parts by weight

Toluene: 2,000 parts by weight.

Next, the resin solution for coating magnetic particles was coated so as to allow the resin component to be approximately 2.5 parts by weight based on 100 parts by weight of spherical ferrite particles (DFC-35-OX, by Dowa IP Creation, Co., Ltd.), magnetic particles, by using SP IRA COTA (Okada Seiko Co., Ltd.) in a heating environment at approximately 70° C., and was heated at approximately 100° C. for approximately 5 hours to remove toluene. Thereafter, coarse particles were removed through a screen having a mesh size of approximately 75 μm by using a sieve shaker (Koei Sangyo Co., Ltd.) to obtain Magnetic Carrier 13.

A shape factor ML²/A of the obtained Magnetic Carrier 13 was approximately 112 and a median particle diameter (D50) based on volume distribution was approximately 37 μm. According to the observation of Magnetic Carrier 13 by a scanning electron microscope, it was confirmed that smooth resin layers were formed on the surfaces of the particles and hydrotalcite particles having a number-average particle diameter of approximately 0.35 μm were uniformly distributed in the resin layer.

Also, as a result of the analysis of the resin component constituting the resin layer, a THF soluble fraction was approximately 100 wt % and a weight-average molecular weight was approximately 40,300.

### Preparation Example 14 of Magnetic Carrier

Magnetic Carrier 14 was obtained in the same manner as in “Preparation Example 1 of Magnetic Carrier” except that hydrotalcite particles were changed to approximately 5 parts by weight of “HT-2”.

### Preparation Example 15 of Magnetic Carrier

Magnetic Carrier 15 was obtained in the same manner as in “Preparation Example 1 of Magnetic Carrier” except that hydrotalcite particles were changed to approximately 17 parts by weight of “HT-3”.

### Preparation Example 16 of Magnetic Carrier

Magnetic Carrier 16 was obtained in the same manner as in “Preparation Example 1 of Magnetic Carrier” except that a MMA/St/DVB copolymer (molar ratio: 84/15.997/0.003) was used as a resin component and hydrotalcite particles were changed to approximately 3 parts by weight of “HT-4”.

### Preparation Example 17 of Magnetic Carrier

Magnetic Carrier 17 was obtained in the same manner as in “Preparation Example 1 of Magnetic Carrier” except that hydrotalcite particles were changed to approximately 30 parts by weight of “HT-5”.

### Preparation Example 18 of Magnetic Carrier

Magnetic Carrier 18 was obtained in the same manner as in “Preparation Example 1 of Magnetic Carrier” except that hydrotalcite particles were changed to approximately 5 parts by weight of “HT-6”.

### Preparation Example 19 of Magnetic Carrier

Magnetic Carrier 19 was obtained in the same manner as in “Preparation Example 1 of Magnetic Carrier” except that a MMA/St copolymer (molar ratio: 91/9) was used as a resin component and hydrotalcite particles were changed to approximately 40 parts by weight of “HT-2”.

### Preparation Example 20 of Magnetic Carrier

Magnetic Carrier 20 was obtained in the same manner as in “Preparation Example 14 of Magnetic Carrier” except that an amount of hydrotalcite particles added was changed to approximately 1 part by weight.

### Preparation Example 21 of Magnetic Carrier

Magnetic Carrier 21 was obtained in the same manner as in “Preparation Example 1 of Magnetic Carrier” except that a MMA/St copolymer (molar ratio: 74/26) was used as a resin component and hydrotalcite particles were changed to approximately 5 parts by weight of “HT-3”.

### Preparation Example 22 of Magnetic Carrier

Magnetic Carrier 22 was obtained in the same manner as in “Preparation Example 1 of Magnetic Carrier” except that a MMA/St copolymer (molar ratio: 64/36) was used as a resin component and hydrotalcite particles were changed to approximately 35 parts by weight of “HT-3”.

### Preparation Example 23 of Magnetic Carrier

Magnetic Carrier 23 was obtained in the same manner as in “Preparation Example 1 of Magnetic Carrier” except that approximately 2 parts by weight of a positively chargeable charge control agent (quaternary ammonium salt, by Oriental Chemical Industries, Co., Ltd.) was used instead of hydrotalcite particles.

Results of preparation examples of the magnetic carrier and preparation examples of the magnetic carrier for comparison are presented in Table 6.

TABLE 6

| | | Prep. | Prep. | Prep. | Prep. | Prep. | Prep. | Prep. | Prep. | Prep. | Prep. | Prep. |
|---|---|---|---|---|---|---|---|---|---|---|---|---|
| | | Exam- | Exam- | Exam- | Exam- | Exam- | Exam- | Exam- | Exam- | Exam- | Exam- | Exam- |
| Preparation Example | | ple | ple | ple | ple | ple | ple | ple | ple | ple | ple | ple |
| of magnetic carrier | | 13 | 14 | 15 | 16 | 17 | 18 | 19 | 20 | 21 | 22 | 23 |
| Magnetic carrier | | Mag- | Mag- | Mag- | Mag- | Mag- | Mag- | Mag- | Mag- | Mag- | Mag- | Mag- |
| obtained | | netic | netic | netic | netic | netic | netic | netic | netic | netic | netic | netic |
| | | Carrier | Carrier | Carrier | Carrier | Carrier | Carrier | Carrier | Carrier | Carrier | Carrier | Carrier |
| | | 13 | 14 | 15 | 16 | 17 | 18 | 19 | 20 | 21 | 22 | 23 |
| Resin | Resin | MMA/ | MMA/ | MMA/ | MMA/ | MMA/ | MMA/ | MMA/ | MMA/ | MMA/ | MMA/ | MMA/ |
| layer | component | St Co. | St Co. | St Co. | St/DVB | St Co. | St Co. | St Co. | St Co. | St Co. | St Co. | St Co. |
| on | of resin | | | | Co. | | | | | | | |
| carrier | layer | | | | | | | | | | | |
| surface | Acrylic | 100 | 100 | 100 | 100 | 100 | 100 | 100 | 100 | 100 | 100 | 100 |
| | resin | | | | | | | | | | | |
| | content | | | | | | | | | | | |
| | (wt %) | | | | | | | | | | | |
| | Acryl | 84 | 84 | 84 | 84 | 84 | 84 | 91 | 84 | 74 | 64 | 84 |
| | monomer | | | | | | | | | | | |
| | unit content | | | | | | | | | | | |
| | C_{A} (Mol %) | | | | | | | | | | | |
| | Hydrotalcite | HT-1 | HT-2 | HT-3 | HT-4 | HT-5 | HT-6 | HT-2 | HT-2 | HT-3 | HT-3 | (Quater- |
| | particle | | | | | | | | | | | nary |
| | | | | | | | | | | | | ammo- |
| | | | | | | | | | | | | nium |
| | | | | | | | | | | | | salt) |
| | Hydrotalcite | 10 | 5 | 17 | 3 | 30 | 5 | 40 | 1 | 5 | 35 | 0 |
| | content | | | | | | | | | | | |
| | C_{H} (parts | | | | | | | | | | | |
| | by weight) | | | | | | | | | | | |
| | C_{H} × 0.38 + C_{A} | 88 | 86 | 90 | 85 | 95 | 86 | 106 | 84 | 76 | 77 | 84 |
| | Amount of | 100 | 100 | 100 | 92 | 100 | 100 | 100 | 98 | 95 | 100 | 100 |
| | THF | | | | | | | | | | | |
| | soluble | | | | | | | | | | | |
| | fraction | | | | | | | | | | | |
| | (wt %) | | | | | | | | | | | |
| | Weight- | 40,300 | 40,300 | 40,300 | 289,700 | 40,300 | 40,300 | 29,000 | 51,600 | 63,000 | 33,100 | 40,300 |
| | average | | | | | | | | | | | |
| | molecular | | | | | | | | | | | |
| | weight | | | | | | | | | | | |
| | (M_{W}) of | | | | | | | | | | | |
| | THF | | | | | | | | | | | |
| | soluble | | | | | | | | | | | |
| | fraction | | | | | | | | | | | |
| Charac- | Surface | Smooth | Smooth | Minor | Uneven- | Minor | Smooth | Uneven- | Smooth | Smooth | Uneven- | Smooth |
| teris- | appearance | | | uneven- | ess | uneven- | | ess | | | ess | |
| tics | of resin | | | ess | | ess | | | | | | |
| | layer | | | | | | | | | | | |
| | Shape | 112 | 112 | 120 | 124 | 122 | 110 | 125 | 110 | 117 | 124 | 114 |
| | factor | | | | | | | | | | | |
| | ML²/A | | | | | | | | | | | |
| | Median | 37 | 37 | 37 | 37 | 37 | 37 | 37 | 37 | 37 | 37 | 37 |
| | particle | | | | | | | | | | | |
| | diameter | | | | | | | | | | | |
| | (D50) (μm) | | | | | | | | | | | |

Co.: Copolymer

Minor unevenness: Occurrence of minor unevenness in a portion

Unevenness: Occurrence of unevenness

### Preparation Example of Toner

### Preparation of Dispersion of Fine Resin Particles

The following components were introduced into a reaction vessel equipped with a stirring device and nitrogen purging was performed while being stirred.
Ion exchanged water: 500 parts by weight
Nonionic surfactant: 6 parts by weight
Anionic surfactant: 12 parts by weight.

Next, a dissolved mixture having the following components was introduced, and emulsified and dispersed in the reaction vessel.
Styrene: 370 parts by weight
n-butyl acrylate: 50 parts by weight
Acrylic acid: 8 parts by weight
Dodecanethiol: 24 parts by weight
Carbon tetrabromide: 4 parts by weight.

After emulsification and dispersion, approximately 50 parts by weight of ion exchanged water having approximately 4 parts by weight of ammonium persurfate dissolved therein was introduced and heated to approximately 70° C. Continuously, emulsion polymerization was performed for 5 hours to obtain a dispersion of fine resin particles.

### Preparation of Dispersion of Carbon Black

The following components were introduced into a reaction vessel equipped with a high-speed stirring device and a dispersion treatment was performed in the reaction vessel to obtain a dispersion of carbon black.
Ion exchanged water: 200 parts by weight
Nonionic surfactant: 5 parts by weight
Carbon black (Brunauer, Emmett, and Teller (BET) specific surface area: approximately 80 m²/g): 50 parts by weight.

### Preparation of Dispersion of Release Agent

The following components were introduced into a reaction vessel equipped with a high-speed stirring device and a dispersion treatment was performed in the reaction vessel to obtain a dispersion of a release agent.
Ion exchanged water: 200 parts by weight
Cationic surfactant: 5 parts by weight
Paraffin wax (peak temperature of maximum endothermic peak by DSC: approximately 75° C.): 80 parts by weight.

### Preparation Example 1 of Black Toner Particles

The following components were introduced into a reaction vessel equipped with a high-speed stirring device.
The above “Dispersion of Fine Resin Particles”: 200 parts by weight
The above “Dispersion of Carbon Black”: 20 parts by weight
The above “Dispersion of Release Agent”: 40 parts by weight
Polyaluminum chloride: 2 parts by weight
Ion exchanged water: 500 parts by weight.

After a dispersion treatment was performed, the dispersion was heated to approximately 45° C. while being stirred and maintained for approximately 30 minutes. A portion of the dispersion in the reaction vessel was sampled to observe with an optical microscope and generation of agglomerated particles having a diameter of approximately 5 μm was confirmed.

Approximately 60 parts by weight of the dispersion of fine resin particles was further added into the dispersion containing the agglomerated particles and the dispersion thus obtained was heated to approximately 50° C. and maintained for approximately 30 minutes.

Thereafter, a 1N sodium hydroxide aqueous solution was introduced into the reaction vessel and a pH of the dispersion was adjusted to approximately 5. After the pH was adjusted, the dispersion was further heated to approximately 95° C. and maintained for approximately 4 hours.

After cooling, the dispersion containing the agglomerated particles was solid-liquid separated in a filter, and a solids content thus obtained was washed several times with ion exchanged water, and then heated and dried by using a Flash jet dryer (Seishin Enterprise Co., Ltd.) to obtain Black Toner Particle 1.

Also, a charge control agent was not used during the preparation of Black Toner Particle 1.

### Preparation Examples 2 and 3 of Black Toner Particles

Black Toner Particles 2 and 3 having different shape factors ML²/A were obtained in the same manner as “Preparation Example 1 of Black Toner Particles” except that operating conditions of the Flash jet dryer was changed.

### Preparation Example of Yellow Toner Particles

A yellow pigment dispersion was obtained in the same manner as in “Preparation of Dispersion of Carbon Black” except that approximately 70 parts by weight of “C. I. Pigment Yellow 180” was used instead of carbon black, and yellow toner particles were then obtained in the same manner as “Preparation Example 1 of Black Toner Particles”.

### Preparation Example of Magenta Toner Particles

A magenta pigment dispersion was obtained in the same manner as “Preparation of Dispersion of Carbon Black” except that approximately 70 parts by weight of “C. I. Pigment Red 122” was used instead of carbon black, and magenta toner particles were then obtained in the same manner as “Preparation Example 1 of Black Toner Particles”.

### Preparation Example of Cyan Toner Particles

A cyan pigment dispersion was obtained in the same manner as in “Preparation of Dispersion of Carbon Black” except that approximately 70 parts by weight of “C. I. Pigment Blue 15:3” was used instead of carbon black, and cyan toner particles were then obtained in the same manner as “Preparation Example 1 of Black Toner Particles”.

### Preparation Example 1 of Black Toner

The following components were introduced into a Henschel mixer, and preliminary mixing was then performed at a circumferential speed of approximately 16 m/sec for approximately 1 minute and dry mixing was performed at a circumferential speed of approximately 40 m/sec for approximately 4 minutes.
Black Toner Particle 1 obtained from “Preparation Example 1 of Black Toner Particles”: 100 parts by weight
Hydrophobically-treated fine titania particles (number-average particle diameter: approximately 0.03 μm): 1.0 part by weight.

After the first dry mixing was performed, the following components were introduced into the mixture thus obtained and dry mixing was again performed for approximately 4 minutes.
Silicone oil-treated fine silica particles (number-average particle diameter: approximately 0.02 μm, treated amount of the oil: approximately 10 parts by weight): 1.2 parts by weight
Hydrophobically-treated fine silica particles (number-average particle diameter: approximately 0.03 μm): 0.5 parts by weight
Fine zinc stearate particles (number-average particle diameter: approximately 7.9 μm): 0.1 parts by weight
Fine cerium oxide particles (number-average particle diameter: approximately 0.65 μm): 0.3 parts by weight.

Sieving was performed after the second dry mixing to remove coarse particles and Toner B7 was obtained.

Toner B7 thus obtained had a weight-average particle diameter (D4) of approximately 6.7 μm, the number of toner particles having a diameter of approximately 3 μm or less of approximately 2.1% in a particle diameter frequency distribution based on the number, and a shape factor ML²/A of approximately 128. A content of fine inorganic particles having a number-average particle diameter ranging from approximately 0.01 μm or more to approximately 0.15 μm or less was approximately 2.7 parts by weight based on 100 parts by weight of the toner particles.

### Preparation Example 2 of Black Toner

Toner B8 was obtained in the same manner as in “Preparation Example 1 of Black Toner” except that toner particles were changed to “Black Toner Particle 2”.

### Preparation Example 3 of Black Toner

Toner B9 was obtained in the same manner as in “Preparation Example 1 of Black Toner” except that toner particles were changed to “Black Toner Particle 3”.

### Preparation Example 4 of Toner

Toner B10 was obtained in the same manner as in “Preparation Example 1 of Toner” except that toner particles were changed to “Black Toner Particle 2” and approximately 1.2 parts by weight of hydrophobically-treated fine silica particles (number-average particle diameter: approximately 0.05 μm) was used instead of the silicone oil-treated fine silica particles.

### Preparation Example 5 of Black Toner

Toner B11 was obtained in the same manner as in “Preparation Example 4 of Black Toner” except that toner particles were changed to “Black Toner Particle 3”.

### Preparation Example 6 of Black Toner

Toner B12 was obtained in the same manner as in “Preparation Example 4 of Black Toner” except that toner particles were changed to “Black Toner Particle 4”.

### Preparation Example 7 of Black Toner

Toner B13 was obtained in the same manner as in “Preparation Example 4 of Black Toner” except that toner particles were changed to “Black Toner Particle 5”.

### Preparation Example of Yellow Toner

Yellow Toner Y was obtained in the same manner as in “Preparation Example 1 of Black Toner” except that toner particles were changed to “Yellow Toner Particles” and an amount of hydrophobically-treated fine titania particles added was changed to approximately 1.1 parts by weight.

### Preparation Example of Magenta Toner

Magenta Toner M was obtained in the same manner as in “Preparation Example 1 of Black Toner” except that toner particles were changed to “Magenta Toner Particles” and the amount of hydrophobically-treated fine titania particles added was changed to approximately 1.2 parts by weight.

### Preparation Example of Cyan Toner

Cyan Toner C was obtained in the same manner as in “Preparation Example 1 of Black Toner” except that toner particles were changed to “Cyan Toner Particles”.

Characteristics of the toners obtained from the foregoing Preparation Examples of toner are summarized and presented in Table 7.

TABLE 7

| | | | | The number of | | In fine inorganic | |
|---|---|---|---|---|---|---|---|
| | | | | toner particles | | particles having a | |
| | | | | having a | | diameter ranging | |
| | | | | diameter of | | from approximately | |
| | | | | approximately | | 0.01 μm or more to | |
| | | | | 3μm or less in | | approximately 0.15 | |
| | | | | a particle | | μm or less | |
| | | | | diameter | | | Presence |
| | | | Weight- | frequency | | | of silicone- |
| | | | average | distribution | | Content | oil treated |
| Prep. | | Toner | particle | based on the | Shape | (parts | fine |
| Example | Toner | particles | diameter | number | factor | by | inorganic |
| of toner | obtained | used | (μm) | (number %) | ML²/A | weight) | particles |
| Prep. | Toner | Black | 6.7 | 2.1 | 128 | 2.7 | present |
| Example 1 | B7 | Toner | | | | | |
| of black | | Particle | | | | | |
| toner | | 1 | | | | | |
| Prep. | Toner | Black | 6.7 | 3.9 | 158 | 2.7 | present |
| Example 2 | B8 | Toner | | | | | |
| of black | | Particle | | | | | |
| toner | | 2 | | | | | |
| Prep. | Toner | Black | 6.7 | 2.0 | 123 | 2.7 | present |
| Example 3 | B9 | Toner | | | | | |
| of black | | Particle | | | | | |
| toner | | 3 | | | | | |
| Prep. | Toner | Black | 6.7 | 4.0 | 158 | 2.4 | absent |
| Example 4 | B10 | Toner | | | | | |
| of black | | Particle | | | | | |
| toner | | 4 | | | | | |
| Prep. | Toner | Black | 6.7 | 1.9 | 123 | 2.4 | absent |
| Example 5 | B11 | Toner | | | | | |
| of balck | | Particle | | | | | |
| toner | | 5 | | | | | |
| Prep. | Toner | Black | 6.6 | 1.6 | 110 | 2.4 | absent |
| Example 6 | B12 | Toner | | | | | |
| of black | | Particle | | | | | |
| toner | | 6 | | | | | |
| Prep. | Toner | Black | 8.4 | 1.0 | 168 | 2.4 | absent |
| Example 7 | B13 | Toner | | | | | |
| of black | | Particle | | | | | |
| toner | | 7 | | | | | |
| Prep. | Yellow | Yellow | 5.6 | 3.2 | 124 | 3.4 | present |
| Example | toner Y | Toner | | | | | |
| of yellow | | Particle | | | | | |
| toner | | | | | | | |
| Prep. | Magenta | Magenta | 7.3 | 1.2 | 143 | 3.5 | present |
| Example | toner M | Toner | | | | | |
| of Magenta | | Particle | | | | | |
| toner | | | | | | | |
| Prep. | Cyan | Cyan | 6.5 | 2.5 | 1278 | 3.5 | present |
| Example | toner C | Toner | | | | | |
| of cyan | | Particle | | | | | |
| toner | | | | | | | |

### Example 12

SAMSUNG MultiXpress CLX-8380 ND (Samsung Electronics Co., Ltd.), a color multifunction printer corresponding to A4 size paper, was remodeled as an image forming apparatus, a image print speed was also increased to approximately 50 sheets/minute (A4 size papers were printed in a longitudinal direction), and a discharge path and a recovery container were newly installed so as to discharge excessive magnetic carriers due to the magnetic carriers supplied from a replenishing developer from a developing device. Further, the time required for the toner in the replenishing developer to reach a detection position of the toner concentration sensor after being replenished to the developing device and passing through an inlet of the developing device was approximately 3 seconds.

A two-component developer prepared by mixing Toner B7 obtained from “Preparation Example 1 of Black Toner” and Magnetic Carrier 13 obtained from “Preparation Example 13 of Magnetic Carrier” so as to allow T/C thereof to be approximately 7% was introduced into a image forming unit for black color of the image forming apparatus as a developer for start, and Toner B7 not combined with magnetic carriers was used as a replenishing developer.

Image output tests were carried out by printing out 30,000 sheets in a monochrome mode in test environments having a different temperature and humidity, and image quality of the obtained images were then evaluated and matching property of the image forming apparatus with the two-component developer was also evaluated. Also, full color copier paper J (approximately 82 g/cm³, A4 size) by Fuji Xerox Co., Ltd. was used as a transfer material.

At this time, the T/C of the two-component developer was used to feedback outputs of the toner concentration detection sensor installed in the developing device to a feeding device of the replenishing developer and to control a replenishing amount of the replenishing developer to be close to a “control target of TIC” set for each test environment.

The details thereof are summarized and presented in the following Table 8.

TABLE 8

| | Temperature/ | Control | Image |
|---|---|---|---|
| Test Environment | Humidity | target of T/C | printing ratio |
| High-temperature | 30° C./85% RH | 6% | 25% |
| and high-humidity | | | |
| Ambient temperature | 23° C./55% RH | 7% | 10% |
| and ambient | | | |
| humidity | | | |
| Low-temperature | 15° C./10% RH | 8% | 5% |
| and low-humidity | | | |

Hereinafter, evaluation of image quality of the printed images and evaluation of matching property of the image forming apparatus with the two-component developer will be described in detail.

[1. Image Density]

Evaluation was performed in the same manner as “Example 1”. Also, each color of yellow, magenta, and cyan was evaluated according to the following criteria.

(In the case of yellow)

A: 0.90 or more (very good)

B: 0.80 or more and less than 0.90 (good)

C: 0.70 or more and less than 0.80 (acceptable level in the present general inventive concept)

D: less than 0.70 (unacceptable level in the present general inventive concept).

(In the case of magenta)

A: 1.10 or more (very good)

B: 0.95 or more and less than 1.10 (good)

C: 0.80 or more and less than 0.95 (acceptable level in the present general inventive concept)

D: less than 0.80 (unacceptable level in the present general inventive concept).

(In the case of cyan)

A: 1.20 or more (very good)

B: 1.05 or more and less than 1.20 (good)

C: 0.90 or more and less than 1.05 (acceptable level in the present general inventive concept)

D: less than 0.90 (unacceptable level in the present general inventive concept).

[2. Reproducibility of Fine Lines]

Fine line patterns having approximately 50 μm long transverse lines in a spacing of approximately 100 μm were printed out and reproducibility of fine lines in the obtained images was evaluated according to the following criteria.

A: changes in a line width of fine lines were less than 10% (very good)

B: changes in a line width of fine lines were 10% or more and less than 20% (good)

C: changes in a line width of fine lines were 20% or more and can also be confirmed easily by the naked eye (acceptable level in the present general inventive concept).

D: breakages in fine lines can also be confirmed by the naked eye (unacceptable level in the present general inventive concept)

[3. Background Fogging]

Background fogging was evaluated in the same manner as “Example 1”.

[4. Carrier Adhesion]

After image printing was terminated in a high-temperature and high-humidity environment, the T/C of the developer was controlled to be approximately 4% and developing of a solid image was initiated under this condition. Power of a main body of the image forming apparatus was turned off and forced to be stopped at a time that approximately 10 cm² or more of the solid image was formed on a photoreceptor drum, and a toner image developed on the photoreceptor drum was recovered by taping it with a Scotch Mending tape (Registered trademark of 3M) and the number of the magnetic carriers mixed therein was identified. The number of the identified magnetic carriers was converted into the number of the identified magnetic carriers per unit area of the solid images and evaluated according to the following criteria.

A: less than 5/cm² (very good)

B: 5/cm² or more and less than 10/cm² (good)

C: 10/cm² or more and less than 20/cm² (acceptable level in the present general inventive concept).

D: 20/cm² or more (unacceptable level in the present general inventive concept)

[5. T/C followability]

The control target of T/C was temporarily changed to 12% at a time in which the number of image prints reached 10,000 sheets in an ambient temperature and ambient humidity environment and a portion of the two-component developer was recovered from a surface of the developing roller after the termination of control. A difference between the T/C value calculated from the results of measuring an amount of magnetic carriers and an amount of toner in the recovered developer and the T/C value obtained from the output value of the toner concentration detection sensor was calculated and evaluated according to the following criteria.

A: less than 5% (very good)

B: 5% or more and less than 10% (good)

C: 10% or more and less than 20% (acceptable level in the present general inventive concept).

D: 20% or more (unacceptable level in the present general inventive concept)

[6. Toner Scattering]

Toner scattering was evaluated in the same manner as “Example 1”.

[7. Image Shade Stain due to Charging Roller]

Image Shade Stain was evaluated in the same manner as “Example 1”.

As a result of the evaluation tests performed according the foregoing, very good results were obtained for each evaluation item. The details of the evaluation results are summarized and presented in the following Table 9.

Also, evaluation tests were terminated in a high-temperature and high-humidity environment, and a portion of the toner was then recovered from the surface of the developing roller. Distribution of charge quantity was measured by using Espart Analyzer EST-3 (Hosokawa Micron, Ltd.) and an amount of a component (positively charged component) having q/d representing a plus value was low at approximately 3 number % and it was confirmed that good negative chargeability was maintained.

### Example 13

Evaluation tests were performed in the same manner as in “Example 12” except that Magnetic Carrier 14 obtained from “Preparation Example 14 of Magnetic Carrier” and Black Toner B8 obtained from “Preparation Example 2 of Black Toner” were used.

### Example 14

Evaluation tests were performed in the same manner as in “Example 12” except that Magnetic Carrier 15 obtained from “Preparation Example 15 of Magnetic Carrier” and Black Toner B9 obtained from “Preparation Example 3 of Black Toner” were used.

### Example 15

Evaluation tests were performed in the same manner as in “Example 12” except that Magnetic Carrier 16 obtained from “Preparation Example 16 of Magnetic Carrier” and Black Toner B10 obtained from “Preparation Example 4 of Black Toner” were used.

### Example 16

Evaluation tests were performed in the same manner as in “Example 12” except that Magnetic Carrier 15 obtained from “Preparation Example 15 of Magnetic Carrier” and Black Toner B11 obtained from “Preparation Example 5 of Black Toner” were used.

### Example 17

Evaluation tests were performed in the same manner as in “Example 12” except that Magnetic Carrier 17 obtained from “Preparation Example 17 of Magnetic Carrier” and Black Toner B12 obtained from “Preparation Example 6 of Black Toner” were used.

### Example 18

Evaluation tests were performed in the same manner as in “Example 12” except that Magnetic Carrier 15 obtained from “Preparation Example 15 of Magnetic Carrier” and Black Toner B13 obtained from “Preparation Example 7 of Black Toner” were used.

### Example 19

Evaluation tests were performed in the same manner as in “Example 12” except that Magnetic Carrier 2 obtained from “Preparation Example 2 of Magnetic Carrier” and Black Toner B11 obtained from “Preparation Example 5 of Black Toner” were used.

### Example 20

Evaluation tests were performed in the same manner as “Example 19” except that Magnetic Carrier 3 obtained from “Preparation Example 3 of Magnetic Carrier” was used.

### Example 21

Evaluation tests were performed in the same manner as in “Example 19” except that Magnetic Carrier 4 obtained from “Preparation Example 4 of Magnetic Carrier” was used.

### Example 22

Evaluation tests were performed in the same manner as in “Example 19” except that Magnetic Carrier 5 obtained from “Preparation Example 5 of Magnetic Carrier” was used.

The evaluation results of “Examples 13 to 18” are summarized and presented in the following Table 9.

TABLE 9

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple | ple | ple | ple | ple | ple | ple | ple | ple | ple | ple |
| | | | 12 | 13 | 14 | 15 | 16 | 17 | 18 | 19 | 20 | 21 | 22 |
| Magnetic carrier used | | | Mag- | Mag- | Mag- | Mag- | Mag- | Mag- | Mag- | Mag- | Mag- | Mag- | Mag- |
| | | | netic | netic | netic | netic | netic | netic | netic | netic | netic | netic | netic |
| | | | Carrier | Carrier | Carrier | Carrier | Carrier | Carrier | Carrier | Carrier | Carrier | Carrier | Carrier |
| | | | 13 | 14 | 15 | 16 | 15 | 17 | 15 | 2 | 3 | 4 | 5 |
| Toner used | | | Toner | Toner | Toner | Toner | Toner | Toner | Toner | Toner | Toner | Toner | Toner |
| | | | B7 | B8 | B9 | B10 | B11 | B12 | B13 | B11 | B11 | B11 | B11 |
| Magnitude of shape factor ML²/A of | | | Small | Small | Small | Small | Small | Large | Small | Small | Small | Small | Small |
| magnetic carrier with respect to toner | | | | | | | | | | | | | |
| Presence of silicone-oil treated fine | | | Present | Present | Present | Absebt | Absent | Absent | Absent | Absent | Absent | Absent | Absent |
| inorganic particles in fine inorganic | | | | | | | | | | | | | |
| particles having a diameter ranging from | | | | | | | | | | | | | |
| approximately 0.01 μm or more to | | | | | | | | | | | | | |
| approximately 0.15 μm or less | | | | | | | | | | | | | |
| Image | High- | Image | A | B | A | B | B | B | B | B | B | C | B |
| quality | temper- | density | | | | | | | | | | | |
| evalua | ature | Reproducibility | A | B | B | C | B | B | C | C | C | C | B |
| tion- | and | of fine | | | | | | | | | | | |
| | high- | lines | | | | | | | | | | | |
| | humid- | Background | A | B | B | C | C | B | C | B | B | C | B |
| | ity | fogging | | | | | | | | | | | |
| | Ambient | Image | A | A | A | B | A | A | B | B | B | C | B |
| | tempera- | density | | | | | | | | | | | |
| | ature | Reproducibility | A | A | A | B | B | A | B | B | C | C | B |
| | and | of fine | | | | | | | | | | | |
| | ambient | lines | | | | | | | | | | | |
| | humid- | Background | A | A | A | B | B | B | C | C | C | C | C |
| | ity | fogging | | | | | | | | | | | |
| | Low- | Image | A | A | A | B | B | A | B | B | C | B | C |
| | temper- | density | | | | | | | | | | | |
| | ature | Reproducibility | A | A | A | B | C | C | C | B | C | B | C |
| | and | of fine | | | | | | | | | | | |
| | low- | lines | | | | | | | | | | | |
| | humid- | Background | A | A | B | C | A | B | B | B | B | C | C |
| | ity | fogging | | | | | | | | | | | |

| | | | | | | | | | | | | |
|---|---|---|---|---|---|---|---|---|---|---|---|---|
| Matching property | Carrier | A | B | B | C | B | B | B | B | C | C | C |
| of Image forming | adhesion | | | | | | | | | | | |
| apparatus | TC | A | A | B | B | B | B | C | C | C | C | B |
| | followability | | | | | | | | | | | |
| | Toner | A | B | A | C | A | B | B | C | B | C | B |
| | scattering | | | | | | | | | | | |
| | Image shade | A | A | A | B | C | B | C | B | C | B | C |
| | stain due to | | | | | | | | | | | |
| | charging roller | | | | | | | | | | | |

### Comparison Example 7

Evaluation tests were performed in the same manner as in “Example 12” except that Magnetic Carrier 18 obtained from “Preparation Example 18 of Magnetic Carrier” and Black Toner B11 obtained from “Preparation Example 5 of Black Toner” were used.

As a result, because the number-average particle diameter of hydrotalcite particles in the coating layer formed on the surface of the magnetic carrier was small at approximately 0.05 μm, charge-imparting ability to the toner was not sufficient and particularly, image formation in a high-temperature and high-humidity environment and matching property with the image forming apparatus was inhibited.

### Comparative Example 8

Evaluation tests were performed in the same manner as in “Comparative Example 7” except that magnetic Carrier 19 obtained from “Preparation Example 19 of Magnetic Carrier” was used.

As a result, because an amount of added hydrotalcite particles in the coating layer formed on the surface of the magnetic carrier was large, charge-imparting ability was excessive and particularly, image formation in a low-temperature and low-humidity was inhibited. Also, defects, such as peeling of a surface resin of the magnetic carrier, also occurred.

Meanwhile, because the shape factor ML²/A of the magnetic carrier was greater than that of the toner in a high-temperature and high-humidity environment, sufficient contact may not be obtained, and thus, defects relating to discharge-imparting ability occurred. Also, because toner spent occurred on the surface of the magnetic carrier, defects, such as carrier adhesion, continuously occurred.

### Comparative Example 9

Evaluation tests were performed in the same manner as “Comparative Example 7” except that magnetic Carrier 20 obtained from “Preparation Example 20 of Magnetic Carrier” was used.

As a result, because an amount of added hydrotalcite particles in the coating layer formed on the surface of the magnetic carrier was small, charge-imparting ability to the toner was not sufficient and particularly, image formation in a high-temperature and high-humidity environment and matching property with the image forming apparatus was inhibited.

### Comparative Example 10

Evaluation tests were performed in the same manner as “Comparative Example 7” except that magnetic Carrier 21 obtained from “Preparation Example 21 of Magnetic Carrier” was used. However, satisfactory image formation and matching property with the image forming apparatus was not obtained.

### Comparative Example 11

Evaluation tests were performed in the same manner as “Comparative Example 7” except that magnetic Carrier 22 obtained from “Preparation Example 22 of Magnetic Carrier” was used. However, satisfactory image formation or matching property with the image forming apparatus was not obtained.

In particular, because the shape factor ML²/A of the magnetic carrier was greater than that of the toner in a high-temperature and high-humidity environment, sufficient contact may not be obtained, and thus, defects relating to discharge-imparting ability occurred. Also, because toner spent occurred on the surface of the magnetic carrier, defects, such as carrier adhesion, continuously occurred.

### Comparative Example 12

Evaluation tests were performed in the same manner as “Comparative Example 7” except that magnetic Carrier 23 obtained from “Preparation Example 23 of Magnetic Carrier” was used.

As a result, because a quaternary ammonium salt was used instead of the hydrotalcite particles, a certain degree of performance was exhibited in an ambient temperature and ambient humidity environment. However, charge-imparting ability was insufficient in a high-temperature and high-humidity environment, and excessive charging also occurred in a low-temperature and low-humidity environment. Therefore, satisfactory images were not obtained.

Also, evaluation tests were terminated in a high-temperature and high-humidity environment, and distribution of charge quantity of the toner from the surface of the developing roller was then measured and an amount of a component having q/d representing a plus value was relatively high at approximately 32 number %.

The evaluation results of “Comparative Examples 7 to 12” are summarized and presented in the following Table 10.

TABLE 10

| | | | Comparative | Comparative | Comparative | Comparative | Comparative | Comparative |
|---|---|---|---|---|---|---|---|---|
| | | | Example | Example | Example | Example | Example | Example |
| | | | 7 | 8 | 9 | 10 | 11 | 12 |
| Magnetic carrier used | | | Magnetic | Magnetic | Magnetic | Magnetic | Magnetic | Magnetic |
| | | | Carrier 18 | Carrier 19 | Carrier 20 | Carrier 21 | Carrier 22 | Carrier 23 |
| Toner used | | | Toner B11 | Toner B11 | Toner B11 | Toner B11 | Toner B11 | Toner B11 |
| Magnitude of shape factor ML²/A of | | | Small | Large | Small | Small | Large | Small |
| magnetic carrier with respect to toner | | | | | | | | |
| Presence of silicone-oil treated fine | | | Absent | Absent | Absent | Absent | Absent | Absent |
| inorganic particles in fine inorganic | | | | | | | | |
| particles having a diameter ranging | | | | | | | | |
| from approximately 0.01 μm or more | | | | | | | | |
| to approximately 0.15 μm or less | | | | | | | | |
| Image | High- | Image density | D | C | D | C | B | C |
| quality | temer- | Reproducibility | D | C | D | D | C | C |
| evalua- | ature | of fine lines | | | | | | |
| tion | and | Background | D | C | D | D | D | D |
| | high- | fogging | | | | | | |
| | humid- | | | | | | | |
| | ity | | | | | | | |
| | Ambient | Image density | C | B | C | C | B | B |
| | temper- | Reproducibility | C | B | D | C | C | C |
| | ature | of fine lines | | | | | | |
| | and | Background | D | C | D | C | C | C |
| | ambient | fogging | | | | | | |
| | humid- | | | | | | | |
| | ity | | | | | | | |
| | Low- | Image density | C | C | C | B | D | B |
| | temper- | Reproducibility | C | D | C | C | D | C |
| | ature | of fine lines | | | | | | |
| | and | Background | B | B | C | B | B | B |
| | low- | fogging | | | | | | |
| | humid- | | | | | | | |
| | ity | | | | | | | |

| | | | | | | | |
|---|---|---|---|---|---|---|---|
| Matching property | Carrier | B | D | B | D | D | B |
| of Image forming | adhesion | | | | | | |
| apparatus | TC | D | C | D | D | D | D |
| | followability | | | | | | |
| | Toner | D | C | D | C | C | D |
| | scattering | | | | | | |
| | Image shade | D | D | D | D | D | D |
| | stain due to | | | | | | |
| | charging roller | | | | | | |

### Example 23

A two-component developer of each color prepared by mixing Toner B7 obtained from “Preparation Example 1 of Black Toner”, Yellow Toner Y obtained from “Preparation Example of Yellow Toner”, Magenta Toner M obtained from “Preparation Example of Magenta Toner”, or Cyan Toner C obtained from “Preparation Example of Cyan Toner” with Magnetic Carrier 13 obtained from “Preparation Example 13 of Magnetic Carrier” so as to allow a T/C ratio thereof to be 7% was introduced into an image forming unit of each color in the image forming apparatus as a developer for start, and a replenishing developer prepared by mixing approximately 10 parts by weight of Magnetic Carrier 13 based on 100 parts by weight of a toner of each color was used as a replenishing developer of each color. In evaluation tests, 100,000 sheets were printed out in a full-color mode under the same condition as in Example 7.

As a result, a good image having no changes in color was continuously printed and thus, initial image quality was maintained even at a time of terminating printing of 100,000 sheets. Also, matching property with the image forming apparatus was good. Details of the evaluation results are summarized and presented in the following Table 11.

TABLE 11

| | | | Example 23 | | | |
|---|---|---|---|---|---|---|
| Magnetic carrier used | | | Magnetic Carrier | Magnetic Carrier | Magnetic Carrier | Magnetic Carrier |
| | | | 13 | 13 | 13 | 13 |
| Toner used | | | Toner B7 | Yellow Toner Y | Magenta Toner M | Cyan Toner C |
| Magnitude of shape factor ML²/A of | | | Small | Small | Small | Small |
| magnetic carrier with respect to toner | | | | | | |
| Presence of silicone-oil treated fine | | | Absent | Absent | Absent | Absent |
| inorganic particles in fine inorganic | | | | | | |
| particles having a diameter ranging | | | | | | |
| from approximately 0.01 μm or more | | | | | | |
| to approximately 0.15 μm or less | | | | | | |
| Image | High- | Image density | A | A | A | A |
| quality | temer- | Reproducibility | A | A | A | A |
| evalua- | ature | of fine lines | | | | |
| tion | and | Background | A | A | A | A |
| | high- | fogging | | | | |
| | humid- | | | | | |
| | ity | | | | | |
| | Ambient | Image density | A | A | A | A |
| | temper- | Reproducibility | A | A | A | A |
| | ature | of fine lines | | | | |
| | and | Background | A | A | A | A |
| | ambient | fogging | | | | |
| | humid- | | | | | |
| | ity | | | | | |
| | Low- | Image density | A | A | A | A |
| | temper- | Reproducibility | A | A | A | A |
| | ature | of fine lines | | | | |
| | and | Background | A | A | A | A |
| | low- | fogging | | | | |
| | humid- | | | | | |
| | ity | | | | | |

| | | | | | |
|---|---|---|---|---|---|
| Matching property | Carrier | A | A | A | A |
| of Image forming | adhesion | | | | |
| apparatus | TC | A | A | A | A |
| | followability | | | | |
| | Toner | A | A | A | A |
| | scattering | | | | |
| | Image shade | A | A | A | A |
| | stain due to | | | | |
| | charging roller | | | | |

The magnetic carriers according to the present general inventive concept have excellent chargeability and thus, may be suitable for a two-component developer and a replenishing developer used in the formation of an image by using a two-component developing method.

A magnetic carrier according to the present general inventive concept may have excellent charge-imparting ability and may exhibit stable performance over a prolonged period of time, and thus, may realize an excellent two-component developer, an excellent replenishing developer, and an excellent method of forming an image.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A magnetic carrier comprising:
a magnetic particle; and
a coating layer disposed on a surface of the magnetic particle,
wherein the coating layer comprises at least a resin component containing approximately 70 wt % or more of a polymer comprising an acrylic monomer C_{A} as a component and hydrotalcite C_{H} dispersed in a form of particles having a number-average particle diameter ranging from approximately 0.1 μm or more to approximately 0.6 μm or less,
a content of the hydrotalcite C_{H} in parts by weight is in a range of approximately 3 parts by weight or more to approximately 30 parts by weight or less based on 100 parts by weight of the resin component, and
a content of the acrylic monomer unit C_{A} in mol % with respect to a total monomer unit included in the resin component and the content of the hydrotalcite C_{H} in parts by weight satisfy the following relationship:
78≦C_{H}×0.38+C_{A}≦99, where 3≦C_{H}≦30.

2. The magnetic carrier of claim 1, wherein the hydrotalcite comprises aluminum and magnesium, and a molar ratio of magnesium to aluminum is in a range of approximately 0.25 or more to approximately 3.50 or less.

3. The magnetic carrier of claim 1, wherein the resin comprises approximately 90 wt % or more of a tetrahydrofuran soluble component and a weight-average molecular weight of the tetrahydrofuran soluble component is in a range of approximately 30,000 or more to approximately 300,000 or less.

4. A two-component developer comprising:
a magnetic carrier; and
a toner,
wherein the magnetic carrier comprises:
a magnetic particle; and
a coating layer disposed on a surface of the magnetic particle,
wherein the coating layer comprises at least a resin component containing approximately 70 wt % or more of a polymer comprising an acrylic monomer C_{A} as a component and hydrotalcite C_{H} dispersed in a form of particles having a number-average particle diameter ranging from approximately 0.1 μm or more to approximately 0.6 μm or less,
a content of the hydrotalcite C_{H} in parts by weight is in a range of approximately 3 parts by weight or more to approximately 30 parts by weight or less based on 100 parts by weight of the resin component, and
a content of the acrylic monomer unit C_{A} in mol % with respect to a total monomer unit included in the resin component and the content of the hydrotalcite C_{H} in parts by weight satisfy the following relationship:
78≦C_{H}×0.38+C_{A}≦99, where 3≦C_{H}≦30.

5. The two-component developer of claim 4, wherein the hydrotalcite comprises aluminum and magnesium, and a molar ratio of magnesium to aluminum is in a range of approximately 0.25 or more to approximately 3.50 or less.

6. The two-component developer of claim 4, wherein the resin comprises approximately 90 wt % or more of a tetrahydrofuran soluble component and a weight-average molecular weight of the tetrahydrofuran soluble component is in a range of approximately 30,000 or more to approximately 300,000 or less.

7. The two-component developer of claim 4, wherein the toner comprises inorganic particles having a number-average particle diameter ranging from approximately 0.01 μm or more to approximately 0.15 μm or less, and
a shape factor ML²/A of the toner is in a range of approximately 120 or more to approximately 160 or less and is greater than that of the magnetic carrier.

8. A replenishing developer used in a two-component developing method in which an electrostatic latent image is developed while the replenishing developer is supplied to a developing device and at least excessive magnetic carriers inside the developing device are discharged from the developing device,
wherein the replenishing developer is a two-component developer comprising a magnetic carrier and a toner,
in which the magnetic carrier comprises:
a magnetic particle; and
a coating layer disposed on a surface of the magnetic particle,
wherein the coating layer comprises at least a resin component containing approximately 70 wt % or more of a polymer comprising an acrylic monomer C_{A} as a component and hydrotalcite C_{H} dispersed in a form of particles having a number-average particle diameter ranging from approximately 0.1 μm or more to approximately 0.6 μm or less,
a content of the hydrotalcite C_{H} in parts by weight is in a range of approximately 3 parts by weight or more to approximately 30 parts by weight or less based on 100 parts by weight of the resin component, and
a content of the acrylic monomer unit C_{A} in mol % with respect to a total monomer unit included in the resin component and the content of the hydrotalcite C_{H} in parts by weight satisfy the following relationship:
78≦C_{H}×0.38+C_{A}≦99, where 3≦C_{H}≦30;
and the two-component developer comprises the magnetic carrier in an amount ranging from approximately 2 parts by weight or more to approximately 50 parts by weight or less based on 100 parts by weight of the toner.

9. The replenishing developer of claim 8, wherein the hydrotalcite comprises aluminum and magnesium, and a molar ratio of magnesium to aluminum is in a range of approximately 0.25 or more to approximately 3.50 or less.

10. The replenishing developer of claim 8, wherein the resin comprises approximately 90 wt % or more of a tetrahydrofuran soluble component and a weight-average molecular weight of the tetrahydrofuran soluble component is in a range of approximately 30,000 or more to approximately 300,000 or less.

11. The replenishing developer of claim 8, wherein the toner comprises inorganic particles having a number-average particle diameter ranging from approximately 0.01 μm or more to approximately 0.15 μm or less, and
a shape factor ML²/A of the toner is in a range of approximately 120 or more to approximately 160 or less and is greater than that of the magnetic carrier.

12. A method of forming an image, the method comprising:
charging an electrostatic latent image carrier by applying a voltage to a charging member;
forming an electrostatic latent image on the electrostatic latent image carrier charged in the charging;
developing the electrostatic latent image by using a two-component developer and forming a toner image on the electrostatic latent image carrier;
transferring the toner image to a transfer material with or without an intermediate transfer body being disposed therebetween; and
fixing the toner image transferred to the transfer material to the transfer material,
wherein the two-component developer comprises a magnetic carrier and a toner, in which the magnetic carrier comprises:
a magnetic particle; and
a coating layer disposed on a surface of the magnetic particle,
wherein the coating layer comprises at least a resin component containing approximately 70 wt % or more of a polymer comprising an acrylic monomer C_{A} as a component and hydrotalcite C_{H} dispersed in a form of particles having a number-average particle diameter ranging from approximately 0.1 μm or more to approximately 0.6 μm or less,
a content of the hydrotalcite C_{H} in parts by weight is in a range of approximately 3 parts by weight or more to approximately 30 parts by weight or less based on 100 parts by weight of the resin component, and
a content of the acrylic monomer unit C_{A} in mol % with respect to a total monomer unit included in the resin component and the content of the hydrotalcite C_{H} in parts by weight satisfy the following relationship:
78≦C_{H}×0.38+C_{A}≦99, where 3≦C_{H}≦30.

13. The method of claim 12, wherein the hydrotalcite comprises aluminum and magnesium, and a molar ratio of magnesium to aluminum is in a range of approximately 0.25 or more to approximately 3.50 or less.

14. The method of claim 12, wherein the resin comprises approximately 90 wt % or more of a tetrahydrofuran soluble component and a weight-average molecular weight of the tetrahydrofuran soluble component is in a range of approximately 30,000 or more to approximately 300,000 or less.

15. The method of claim 12, wherein the toner comprises inorganic particles having a number-average particle diameter ranging from approximately 0.01 μm or more to approximately 0.15 μm or less, and
a shape factor ML²/A of the toner is in a range of approximately 120 or more to approximately 160 or less and is greater than that of the magnetic carrier.

16. The method of claim 12, wherein, in the charging, the electrostatic latent image carrier is charged by applying only a direct voltage to a charging member rotatably installed to be in contact with a surface of the electrostatic latent image carrier.

17. The method of claim 12, wherein the developing is performed in a developing device while a replenishing developer comprising the toner is supplied from a developer supply unit,
the supply of the replenishing developer is controlled based on a result of detection of a toner concentration transferred from a toner concentration detection unit installed in the developing device for measuring a toner concentration in the two-component developer used for development, and
the toner concentration is detected in a range in which a toner supplied from the developer supply unit into the developing device reaches within approximately 5 seconds.

18. The method of claim 17, wherein the replenishing developer is used in a two-component developing method in which an electrostatic latent image is developed while the replenishing developer is supplied to a developing device and at least excessive magnetic carriers inside the developing device are discharged from the developing device,
wherein the replenishing developer is a two-component developer comprising the magnetic carrier and the toner, in which the two-component developer comprises the magnetic carrier in an amount ranging from approximately 2 parts by weight or more to approximately 50 parts by weight or less based on 100 parts by weight of the toner.

19. The method of claim 17, wherein the hydrotalcite comprises aluminum and magnesium, and a molar ratio of magnesium to aluminum is in a range of approximately 0.25 or more to approximately 3.50 or less.

20. The method of claim 17, wherein the resin comprises approximately 90 wt % or more of a tetrahydrofuran soluble component and a weight-average molecular weight of the tetrahydrofuran soluble component is in a range of approximately 30,000 or more to approximately 300,000 or less.
